(19) United States
(12) Patent Application Publication
(10) Pub. No.: US 2010/0104878 A1
(43) Pub. Date: Apr. 29, 2010

(54) BONDING METHOD, BONDED STRUCTURE, AND OPTICAL ELEMENT

(75) Inventors: Yasuhide MATSUO, Matsumoto (JP); Kenji OTSUKA, Suwa (JP); Takenori SAWAI, Fujimi (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/605,692

(22) Filed: Oct. 26, 2009

(30) Foreign Application Priority Data
Oct. 28, 2008 (JP) 2008-277465

(51) Int. Cl. B32B 17/06; B32B 38/10

(52) U.S. Cl. 428/429; 156/155

(57) ABSTRACT

A bonding method includes forming a bonding film on a surface of a base member by plasma polymerization, the bonding film including an Si skeleton of a random atomic structure including a siloxane (Si—O) bond and leaving groups binding to the Si skeleton; applying UV light to the bonding film to eliminate the leaving groups at the surface of the bonding film from the Si skeleton so as to provide adhesion properties to the bonding film, an accumulated amount of the UV light being adjusted to control a refractive index of the bonding film; and bonding the base member and an object together via the bonding film to obtain a bonded structure.

The entire disclosure of Japanese Patent Application No. 2008-277465, filed Oct. 28, 2008 is expressly incorporated by reference herein.

### BACKGROUND

1. Technical Field

The present invention relates to a bonding method, a bonded structure, and an optical element.

2. Related Art

Conventionally, two base members are bonded (adhesively bonded) together by an adhesive such as an epoxy, urethane, or silicone.

The adhesives can exhibit adhesion properties regardless of the material of the members to be bonded together, thereby achieving bonding between various combinations of members made of different materials.

For example, wavelength plates are at type of optical element serving to produce a phase difference in transmitted light. The wavelength plate is formed by combining two sheets of substrates made of birefringence crystal such as quartz crystal. The substrates are bonded together by an adhesive.

When bonding the substrates together by an adhesive as above, a liquid or paste adhesive is applied on a bonded surface of at least one of the substrates to bond the substrates to each other via the applied adhesive. Then, heat or light is applied to cure the adhesive, thereby achieving bonding between the substrates.

Optical transmittance of the wavelength plate is influenced by a refractive index difference between the adhesive and the substrates. Thus, to increase the optical transmittance, it is desirable to reduce the refractive index difference. However, in general, the refractive index of the adhesive tends to be uniquely determined in accordance with a composition of the adhesive, so that the refractive index can hardly be adjusted to an arbitrary value.

Accordingly, for example, JP-A-1995-188638 discloses an adhesive composition that contains a refractive index adjuster for adjusting the refractive index of an adhesive in accordance with a refractive index of a substrate. The refractive index adjuster-containing adhesive composition includes a urethane hot melt adhesive as its main component and an aromatic organophosphorus compound as an additive. Then, the refractive index of the refractive index adjuster-containing adhesive composition can be adjusted by changing an amount of the additive to be added.

Usually, however, such an additive is added in production of an adhesive and thus, the refractive index of the adhesive cannot be adjusted after production. Consequently, according to refractive indexes of substrates to be bonded together, it is necessary to prepare many kinds of adhesives having different refractive indexes. This is extremely inefficient for industrial use.

Additionally, it is difficult to apply the adhesive evenly with a predetermined thickness, inevitably causing a distance variation between the substrates. In this case, various kinds of aberrations occur on the wavelength plate, such as a wave surface aberration, so that optical performance of the wavelength plate may be reduced.

Furthermore, the adhesive is made of a resin material and thus vulnerable to the influence of light which may change the refractive index over time. This is another major problem in terms of bonding of an optical component.

### SUMMARY

A bonding method is provided for strongly bonding two base members to each other via a bonding film having high light induced damage resistance and high size precision and capable of facilitating adjustment of a refractive index by adjusting conditions for application of UV light. A bonded structure formed by strongly bonding two base members to each other with high size precision by using the bonding method is also provided. An optical element using the bonded structure is additionally provided.

Attempts to achieve the above advantages are exemplified by the following aspects and preferred features.

A bonding method according to a first aspect includes preparing a base member and an object to be bonded to form a bonding film on a surface of the base member by plasma polymerization, the bonding film including an Si skeleton of a random atomic structure including a siloxane (Si—O) bond and a leaving group binding to the Si skeleton; applying UV light to the bonding film to eliminate the leaving group included in the bonding film from the Si skeleton so as to provide adhesion properties to the bonding film, an accumulated amount of the UV light being adjusted to adjust a refractive index of the bonding film; and bonding together the base member and the object to be bonded via the bonding film to obtain a bonded structure.

In this manner, the two constituent members can be strongly bonded together via the bonding film having high light resistance and high size precision. In addition, in the bonding method, the refractive index of the bonding film can be easily adjusted by adjusting conditions for the UV light applied to the bonding film.

Preferably, in the bonding method of the aspect, in all atoms except for H atoms included in the bonding film, a sum of a content of Si atoms and a content of O atoms ranges from 10 to 90 atom percent.

In this manner, in the bonding film, the Si atoms and the O atoms form a strong network, so that the bonding film in itself can be made strong. In addition, the bonding film thus formed exhibits particularly high bonding strength against the base member and the object to be bonded.

Preferably, in the bonding method of the aspect, a ratio of the Si atoms and the O atoms in the bonding film ranges from 3:7 to 7:3.

In this manner, stability of the bonding film can be increased, so that the base member and the object to be bonded can be more strongly bonded together.

Preferably, in the bonding method of the aspect, a degree of crystallization of the Si skeleton is equal to or less than 45%.

Thereby, the Si skeleton can include a particularly random atomic structure, whereby the bonding film obtained can have high size precision and high adhesion properties.

Preferably, in the bonding method of the aspect, the bonding film includes an Si—H bond.

The Si—H bond seems to inhibit regular generation of the siloxane bond, so that the siloxane bond is formed in a manner avoiding the Si—H bond, thus reducing a structural regularity of the Si-skeleton. Accordingly, using plasma polymerization allows the Si—H bond to be included in the bonding film, thereby resulting in efficient formation of the Si skeleton having a low degree of crystallization.

Preferably, in the bonding method, when a peak intensity of the siloxane bond is set to 1 in an infrared absorption spectrum of the bonding film including the Si—H bond, a peak intensity of the Si—H bond ranges from 0.001 to 0.2.

Thereby, the atomic structure in the bonding film becomes relatively most random with respect to the range. Accordingly, the bonding film becomes particularly excellent in bonding strength, chemical resistance, and size precision.

Preferably, in the bonding method of the aspect, the leaving group includes at least one of an H atom, a B atom, a C atom, an N atom, an O atom, a P atom, an S atom, a halogen atom, and an atom group in which each of the atoms is arranged so as to bind to the Si skeleton.

The above leaving group including at least one of them is relatively excellent in selectivity of binding/leaving by application of energy and thus can be relatively easily and evenly eliminated by application of energy, thereby further improving adhesion properties of the bonding film.

Preferably, in the bonding method, the leaving group is an alkyl group.

Thereby, the bonding film obtained is excellent in environmental resistance and chemical resistance.

Preferably, in the bonding method, when the peak intensity of the siloxane bond is set to 1 in the infrared absorption spectrum of the bonding film including a methyl group as the leaving group, a peak intensity of the methyl group ranges from 0.05 to 0.45.

Thereby, a content of the methyl group can be optimized. This does not allow the methyl group to inhibit generation of the siloxane bond more than necessary, while allowing generation of a necessary and sufficient number of active bonds in the bonding film. As a result, the bonding film becomes sufficiently adhesive. In addition, the bonding film obtains sufficient environmental resistance and chemical resistance attributed to the methyl group.

Preferably, in the bonding method of the aspect, the bonding film includes an active bond after the leaving group present at least near a surface of the bonding film is eliminated from the Si skeleton.

Thereby, based on chemical bonding, the bonding film can be strongly bonded to the object to be bonded.

Preferably, in the bonding method, the active bond is a dangling bond or a hydroxyl group.

Thereby, the bonding film can be particularly strongly bonded to the object to be bonded.

Preferably, in the bonding method of the aspect, the bonding film is mainly made of polyorganosiloxane.

Thereby, the bonding film obtained exhibits higher adhesion properties. In addition, the bonding film has high environmental resistance and high chemical resistance. Thus, for example, the bonding film may be useful in bonding a base member that will be exposed to a chemical agent or the like over a long period of time.

Preferably, in the bonding method, the polyorganosiloxane predominantly contains a polymer of octamethyltrisiloxane.

Thereby, the bonding film obtained exhibits particularly excellent adhesion properties.

Preferably, in the bonding method of the aspect, in the plasma polymerization, a high frequency output density for generating plasma ranges from 0.01 to 100 W/cm².

Thereby, it can be prevented that plasma energy is excessively applied to raw gas because the high frequency output density is too high, as well as it can be ensured that the Si skeleton having the random atomic structure is formed.

Preferably, in the bonding method of the aspect, a mean thickness of the bonding film ranges from 1 to 1,000 nm.

This can prevent extreme reduction in the size precision of a bonded structure formed by bonding together the base member and the object to be bonded, as well as can increase bonding strength between the base member and the object to be bonded.

Preferably, in the bonding method of the aspect, the bonding film is a solid having no fluidity.

Thereby, the size precision of the bonded structure can be particularly higher than in conventional bonding methods. Additionally, as compared to the conventional methods, strong bonding can be achieved in a short time.

Preferably, in the bonding method of the aspect, the refractive index of the bonding film is adjusted to a predetermined value ranging from 1.35 to 1.6.

In the bonding film thus formed, the refractive index is relatively close to a refractive index of quartz crystal or quartz glass. Accordingly, for example, the bonding film is suitably used to produce an optical component having a structure in which an optical path passes through the bonding film.

Preferably, in the bonding method of the aspect, at the UV-light application step, the UV light has a wavelength ranging from 126 to 300 nm.

Using the UV light having the wavelength of the above range hardly allows cutting of the siloxane bond included in the bonding film, while facilitating cutting of a chemical bond having a smaller binding energy than the siloxane bond. As a result, an Si—O—Si bond as a basic skeleton is hardly cut, whereas an organic component can be easily eliminated. Thereby, destruction of the bonding film can be prevented, while ensuring change in the refractive index of the bonding film.

Preferably, in the bonding method of the aspect, at the UV-light application step, the accumulated amount of the UV light ranges from 10 mJ/cm² to 1 kJ/cm².

Thereby, the leaving group included in the bonding film is not entirely eliminated and a part of the leaving group can be left in the bonding film.

Preferably, in the bonding film of the aspect, at the UV-light application step, an atmosphere for applying the UV light to the bonding film is a dry atmosphere.

Thereby, it can be prevented that water vapor in the atmosphere adsorbs to a place where the chemical bond has been cut by application of the UV light in the bonding film, leading to prevention of an undesired change in the composition of the bonding film. Consequently, the refractive index of the bonding film can be changed in accordance with a correlation with the accumulated amount of the UV light, so that the refractive index can be set closer to an intended value.

Preferably, in the bonding method of the aspect, at the UV-light application step, an atmosphere for applying the UV light to the bonding film is an inert gas atmosphere.

This can prevent degeneration or deterioration of the bonding film caused as a result of oxidization due to application of the UV light.

Preferably, in the bonding method of the aspect, at least one of the base member and the object to be bonded is made of a light-transmitting material, and at the UV-light application step, the refractive index of the bonding film is adjusted in accordance with a refractive index of the light-transmitting material.

This allows production of an optical component exhibiting high optical performance.

Preferably, in the bonding method, the light-transmitting material is quartz glass or quartz crystal.

Those materials are suitably used as optical component materials and have a refractive index relatively closer to the refractive index of the bonding film. Accordingly, for example, composite optical elements achieving high optical transmission can be easily produced by adjusting the refractive index of the bonding film so as to be approximately equal to that of quartz crystal and then by bonding together optical components made of quartz crystal via the bonding film thus formed.

Preferably, the bonding method of the aspect further includes exposing the bonding film to plasma between the UV-light application step and the bonding step.

This allows stable adhesion properties to be produced on the corresponding surface of the bonding film. As a result, based on chemical bonding, the bonding film can be strongly and stably bonded to the object to be bonded. In addition, since the plasma acts selectively on the surface of the bonding film, active bonds are generated on the bonding film, whereas any elimination of the leaving group does not occur inside the bonding film. Thus, without causing almost any change in the refractive index of the bonding film, the bonding film can have stable adhesion properties.

Preferably, in the bonding method, the plasma is atmospheric pressure plasma.

This can prevent damage to the bonding film, whereby the bonding film can exhibit high adhesion properties and high optical performance.

Preferably, in the bonding method of the aspect, at the bonding-film formation step, the object to be bonded is provided by forming a same bonding film as the bonding film of the base member on a surface of a base member, then, at the UV-light application step, the UV light is applied to both of the bonding films; and, at the bonding step, the base member and the object to be bonded are bonded together such that the bonding films are closely adhered to each other so as to obtain the bonded structure.

Thereby, the base member and the object to be bonded can be more strongly bonded together.

A bonded structure according to a second aspect includes two base members bonded by the bonding method of the first aspect.

Thereby, the bonded structure obtained is formed by strongly bonding together the two base members via the bonding film excellent in light resistance and size precision and having an intended refractive index.

An optical element according to a third aspect includes the bonded structure of the second aspect.

Thereby, there can be obtained an optical element exhibiting high optical performance.

### BRIEF DESCRIPTION OF THE DRAWINGS

Embodiments will be described with reference to the accompanying drawings, wherein like numbers reference like elements.

FIGS. 1A to 1D are longitudinal sectional views illustrating a bonding method according to a first embodiment.

FIGS. 2E and 2F are longitudinal sectional views illustrating the bonding method according to the first embodiment.

FIG. 3 is a partially enlarged view showing a state of a bonding film before energy application in the bonding method of the first embodiment.

FIG. 4 is a partially enlarged view showing a state of the bonding film after energy application in the bonding method of the first embodiment.

FIG. 5 is a longitudinal sectional view schematically showing a plasma polymerization apparatus used in the bonding method of the first embodiment.

FIGS. 6A to 6C are longitudinal sectional views illustrating a method for forming the bonding film on a base member.

FIGS. 7A to 7E are longitudinal sectional views illustrating a bonding method according to a second embodiment.

FIGS. 8A to 8E are longitudinal sectional views illustrating a bonding method according to a third embodiment.

FIGS. 9A to 9E are longitudinal sectional views illustrating a bonding method according to a fourth embodiment.

FIG. 10 is a perspective view showing a wavelength plate (an optical element).

### DESCRIPTION OF EXEMPLARY EMBODIMENTS

Embodiments will be described in detail with reference to the accompanying drawings.

Bonding Method

In a bonding method according to each of the embodiments, a base member 2 and an object to be bonded 4 are bonded together via a bonding film 3. The bonding method allows the base member 2 and the object to be bonded 4 to be strongly bonded together with high size precision. The bonding film 3 is formed by plasma polymerization and includes an Si skeleton with a random atomic structure including a siloxane (Si—O) bond and leaving groups bonded to the Si skeleton.

When UV light is applied to the bonding film 3 thus formed, some of the leaving groups present in the bonding film are separated from the Si skeleton, whereby a refractive index of the bonding film 3 is changed. Accordingly, by adjusting an accumulated amount of the UV light applied, the refractive index of the bonding film 3 can be adjusted which results in obtaining a desired refractive index of the bonding film 3. Thus, for example, the bonding film 3 can be useful to produce an optical component exhibiting high optical performance.

The bonding film 3 subjected to the UV irradiation becomes adhesive due to separation of the leaving group.

In addition, when the bonding film 3 is exposed to plasma, the leaving groups near a surface of the bonding film 3 are separated from the Si skeleton, thereby obtaining more stable adhesion. By using the stable adhesion of the bonding film 3, the base member 2 and the object to be bonded 4 can be strongly bonded together via the bonding film 3 even at a low temperature and thereby a highly reliable bonded structure 5 can be obtained.

### First Embodiment

A bonding method according to a first embodiment will be described below.

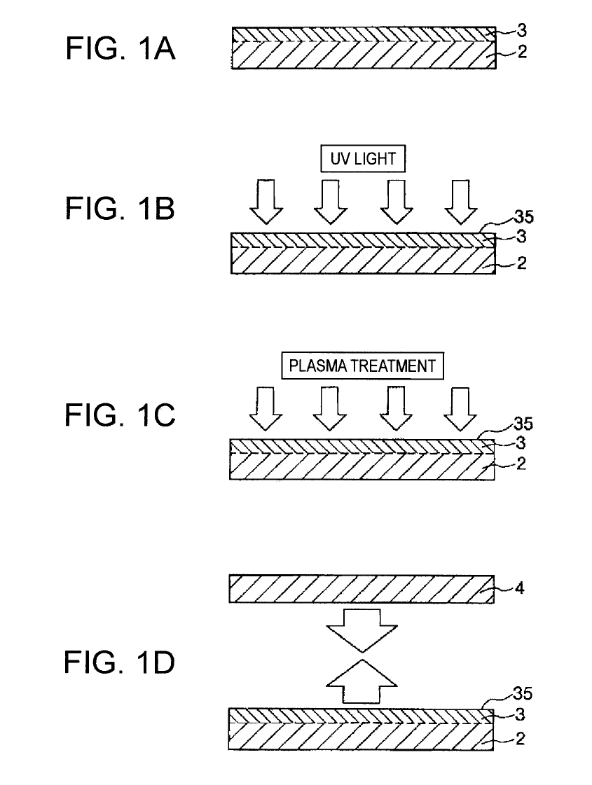

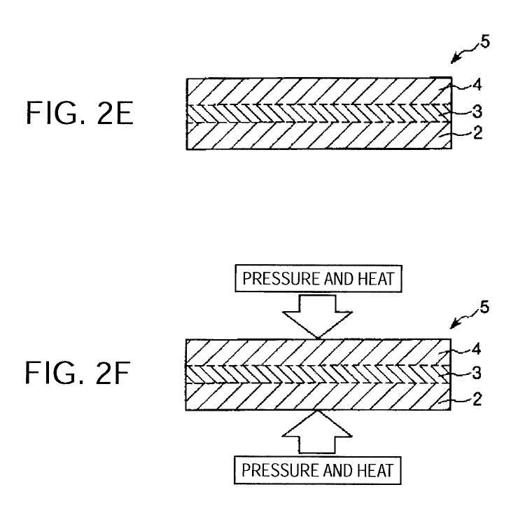

FIGS. 1A to 1D and FIGS. 2E and 2F are longitudinal sectional views illustrating the bonding method of the first embodiment. In the description below, upper and lower sides, respectively, in FIGS. 1A to 2F, will be referred to as “top” and “bottom”, respectively.

The bonding method of the first embodiment includes preparing the base member 2 and the object to be bonded 4 to form the bonding film 3 on a surface of the base member 2 by plasma polymerization (step 1); applying a predetermined accumulated amount of UV light to obtain the bonding film 3 having a predetermined refractive index (step 2); exposing the bonding film 3 to plasma; and bonding together the base member 2 and the object to be bonded 4 via the bonding film 3 to obtain the bonded structure 5 (step 3). The steps will be sequentially described below.

1. First, the base member 2 and the object to be bonded 4 are prepared.

Examples of material for the base member 2 include polyolefins such as polyethylene, polypropylene, ethylene-propylene copolymer, and ethylene-vinyl acetate copolymer (EVA); polyesters such as cyclo-polyolefin, modified-polyolefin, polyvinyl chloride, polyvinylidene chloride, polystyrene, polyamide, polyimide, polyamide-imide, polycarbonate, poly-(4-methylpentene-1), ionomer, acryl resin, polymethyl methacrylate, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyethylene terephthalate (PET), polyethylene naphthalate, polybutylene terephthalate (PBT), and polycyclohexylenedimethylene terephthalate (PCT); thermosetting elastomers such as polyether, polyetherketone (PEK), polyether ether ketone (PEEK), polyetherimide, polyacetal (polyoxymethylene:POM), polyphenyleneoxide, modified-polyphenyleneoxide, polysulfone, polyethersulfone, polyphenylene sulfide, polyarylate, aromatic polyester (liquid crystal polymer), polytetrafluoroethylene, polyvinylidene fluoride, other fluororesins, styrenes, polyolefins, polyvinyl chlorides, polyurethanes, polyesters, polyamides, polybutadienes, trans-polyisoprenes, fluoro rubbers, and chlorinated polyethylenes; resin materials such as epoxy resin, phenol resin, urea resin, melamine resin, aramid resin, unsaturated polyester, silicone resin, polyurethane, copolymers mainly containing them, polymer blends, and polymer alloys; metals such as Fe, Ni, Co, Cr, Mn, Zn Pt, Au, Ag, Cu, Pd, Al, W, Ti, V, Mo, Nb, Zr Pr, Nd, and Sm, alloys of the metals; metallic materials such as carbon steel, stainless steel, indium-tin oxide (ITO), and gallium arsenide; silicon materials such as monocrystalline silicon, polycrystalline silicon, and amorphous silicon; glass materials such as silicate glass (quartz glass), alkaline silicate glass, soda-lime glass, potash-lime glass, lead-alkali glass, barium glass, and borosilicate glass; ceramic materials such as alumina, zirconia, ferrite, silicon nitride, aluminum nitride, boron nitride, titanium nitride, silicon carbide, boron carbide, titanium carbide, tungsten carbide; carbon materials such as graphite, and composite materials including a combination of each one kind or two or more kinds of the materials.

The material of the object to be bonded 4 may be selected from the material examples of the base member 2 according to need, for example. The material of the base member 2 may be the same as or different from the material of the object to be bonded 4.

In addition, the surface of the base member 2 and a surface of the object to be bonded 4 may be subjected to plating such as Ni plating, passivation such as chromating, nitriding, or the like.

In the present embodiment, the base member 2 and the object to be bonded 4 each have a plate shape as shown in FIGS. 1A to 1D. A mean thickness of the plate shape preferably ranges from approximately 0.01 to 10 mm and more preferably ranges from approximately 0.1 to 3 mm. Setting the mean thickness of each of the base member 2 and the object to be bonded 4 in the above range facilitates bending of the base member 2 and the object to be bonded 4, so that the base member 2 and the object to be bonded 4 can be sufficiently deformed, thereby significantly increasing adhesion between the members 2 and 4. This can improve the strength of bonding between the base member 2 and the object to be bonded 4.

Next, as shown in FIG. 1A, the bonding film 3 is formed on the surface of the base member (step 1). The bonding film 3 is located between the base member 2 and the object to be bonded 4 to bond the members 2 and 4 to each other.

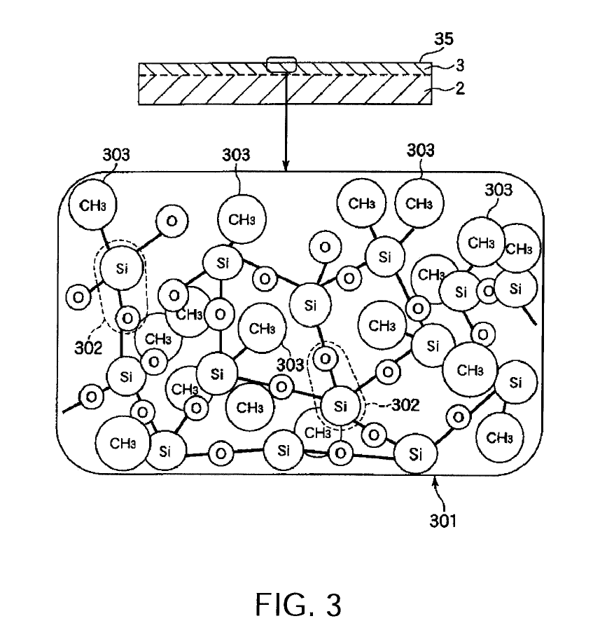

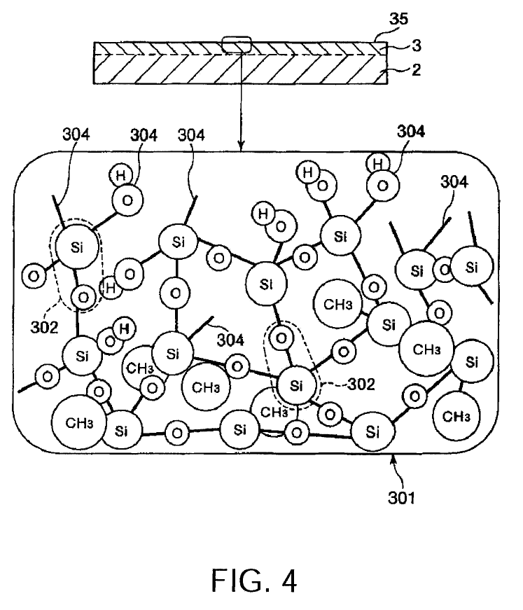

The bonding film 3 includes an Si skeleton 301 including a siloxane (Si—O) bond 302 and having a random atomic structure, as shown in FIGS. 3 and 4, and leaving groups 303 bonding to the Si skeleton 301.

Details of the bonding film 3 will be described later.

In at least a region of the base member 2 intended to adhere to the bonding film 3, preferably, a surface treatment in accordance with the material of the base member 2 is performed in advance to increase adhesion between the base member 2 and the bonding film 3 before forming the bonding film 3.

The surface treatment may be a physical surface treatment such as sputtering or blast treatment, a plasma treatment using oxygen plasma or nitrogen plasma, a chemical surface treatment such as corona discharge, etching, electron beam radiation, UV radiation, ozone exposure, or a combination of those treatments. Performing such a surface treatment can lead to cleaning and activation of the region of the base member 2 intended to form the bonding film 3. This enables the base member 3 and the bonding film 3 to be more strongly bonded to each other.

Among those surface treatments, using plasma treatment particularly can increase the bond of the base member 2 with the bonding film 3.

When the base member 2 to be surface-treated is made of a resin material (a high polymer material), particularly, a surface treatment such as corona discharge or nitrogen plasma may be suitably used.

Depending on the material of the base member 2, without any of the surface treatments, the bonding strength between the surface of the base member 2 and the bonding film 3 can be sufficiently increased. Examples of such effective materials for the base member 2 include materials mainly containing the above-described various metallic materials, silicon materials, and glass materials.

The surface of the base member 2 made of any of the above materials is covered with an oxide film where a highly active hydroxyl group is bonded to a surface of the oxide film. Accordingly, using the base member 2 thus formed allows the adhesion strength between the base member 2 and the bonding film 3 to be increased without any surface treatment as above.

In that case, it may not be necessary to make the entire base member 2 of any of the materials as mentioned above. Instead, a portion near a surface of the region of the base member 2 intended to adhere to the bonding film 3 may be made of any of the materials above.

Similarly, depending on the material of the object to be bonded 4, without any of the above surface treatments, the bonding strength between the surface of the base member 2 and the bonding film 3 can be sufficiently increased. Examples of material for the object to be bonded 4 exhibiting such an advantageous effect include the same materials as those for the base member 2, namely, metallic, silicon, or glass materials.

When a region of the object to be bonded 4 intended to be closely adhered to the bonding film 3 includes a group and/or a substance as mentioned below, the bonding strength between the base member 2 and the object to be bonded 4 can be sufficiently increased without any of the surface treatments above.

Examples of the group and/or the substance include functional groups such as a hydroxyl group, a thiol group, a carboxyl group, an amino group, a nitro group, and an imidazole group, unsaturated bonds such as radicals, ring-opened molecules, double bonds, and triple bonds, halogens such as F, Cl, Br and I, and peroxides. Among these, at least one group or substance may be selected.

Preferably, any of the surface treatments as mentioned above may be appropriately selected to obtain the surface including the at least one group or substance.

Instead of such a surface treatment, preferably, an intermediate layer is pre-formed on at least the region of the base member 2 intended to adhere to the bonding film 3 and on at least the region of the object to be bonded 4 intended to be closely adhered to the bonding film 3.

The intermediate layer can have any function. The intermediate layer, for example, preferably has a function of increasing the adhesion with the bonding film 3, a cushioning function (a buffer function), a function of mitigating stress concentration, or the like. Using the intermediate layer thus formed, there can be obtained a highly reliable bonded structure.

Examples of material for the intermediate layer include metals such as aluminum and titanium, oxide materials such as an metal oxide and a silicon oxide, nitride materials such as a metal nitride and a silicon nitride, carbons such as graphite and diamond carbon, and self-organizing film materials such as a silane coupling agent, a thiol compound, a metal alkoxide, and a metal-halogen compound, resin materials such as resin adhesives, resin films, resin coating materials, rubber materials, and elastomers. Among them, one kind thereof or a combination of two or more kinds thereof may be used as the material for the intermediate layer.

Among those kinds of the materials, using the oxide materials for the intermediate layer can particularly increase the bonding strength in the bonded structure 5.

2. Next, as shown in FIG. 1B, UV light is applied to the bonding film 3 (step 2).

By application of the UV light, the leaving groups 303 are separated from the Si skeleton 301 in the bonding film 3.

Due to separation of the leaving groups 303 as mentioned above, composition of the bonding film 3 is changed, thereby changing a refractive index of the bonding film 3. In this case, the change in the refractive index is correlated with an amount of separated leaving groups 303, and also is correlated with an accumulated amount of the UV light. Based on the correlation, adjustment of the accumulated amount of the UV light applied to the bonding film 3 allows adjustment of the refractive index of the bonding film 3.

Specifically, when the UV light is applied to the bonding film 3 including organic groups as the leaving groups 303 and the Si skeleton 301 to which the organic groups are bonded, the organic group is separated from the Si skeleton 301, whereby the refractive index of the bonding film 3 is reduced. In this case, by adjusting at least one of the accumulated amount of the UV light, namely, at least one of the intensity of the UV light applied and the duration of exposure to the UV light, an amount of reduction in the refractive index can be adjusted, thereby enabling the refractive index of the bonding film 3 to be reduced down to an intended value. Accordingly, for example, the bonding film 3 can be easily obtained that has a predetermined refractive index difference with respect to a refractive index of the base member 2 or that has the same refractive index as that of the base member 2.

Regarding the UV light applied at the present step, in order not to separate of all of the leaving groups 303 in the bonding film 3, the accumulated amount of the light applied is adjusted based on the correlation between the accumulated amount of the UV light applied to the bonding film 3 and the refractive index of the bonding film 3 described above. Thereby, even after application of the UV light, part of the leaving groups 303 remain in the bonding film 3. The remaining leaving groups 303 contribute to provide adhesion to the bonding film 3 at a later step.

Preferably, the energy of the UV light applied at the present step hardly cuts the siloxane (the Si—O) bond in the bonding film 3 and easily cuts a chemical bond having a smaller bonding energy than the siloxane bond, such as an Si—C bond. Using LTV light having such characteristics can prevent complete destruction of the Si skeleton in the bonding film 3, as well as can cut only a part of such a chemical bond in the bonding film 3, thereby enabling the refractive index of the bonding film 3 to be reduced, as described above.

Specifically, the UV light used has a wavelength ranging preferably from 126 to 300 nm, and more preferably from 160 to 200 nm. The UV light having a wavelength of the above range has energy satisfying the above preferred condition. Thus, a basic skeleton Si—O—Si is hardly cut, whereas the organic component can be easily separated, thereby preventing destruction of the bonding film 3 and also ensuring a change in the refractive index of the bonding film 3.

In addition, the accumulated amount of the UV light ranges preferably from 10 mJ/cm² to 1 kJ/cm², and more preferably from 100 mJ/cm² to 100 J/cm². By setting the accumulated amount of the UV light in the above range, the leaving groups 303 in the bonding film 3 are not entirely separated and can be partially left in the bonding film 3.

Additionally, as mentioned above, the accumulated amount of the UV light is represented by a product of the intensity and the duration of exposure to the UV light. Accordingly, when a UV lamp is used as a light source of the UV light, the intensity of light from the lamp ranges preferably from 1 mW/cm² to 1 W/cm², and more preferably from 5 mW/cm² to 50 mW/cm².

The application time of the UV light is calculated from the above range of the accumulated amount of the UV light and the above range of the intensity of the light.

Furthermore, the UV light may be applied continuously or intermittently for a predetermined time.

The UV light may be applied as laser light. Laser light has an extremely high directivity, so that the UV light can be locally applied to the bonding film 3.

The UV light can be applied to the bonding film 3 in any atmosphere, but is preferably applied in a dry atmosphere. This can prevent atmospheric water vapor from adsorbing to a place where chemical bonding has been cut by application of the UV light, thereby preventing an undesired change in the composition of the bonding film 3. As a result, the refractive index of the bonding film 3 can be changed in accordance with the correlation of the accumulated amount of the UV light, so as to allow the refractive index to be moved closer to an intended value.

Specifically, the atmosphere dew point is preferably equal to or less than minus 10° C., and more preferably equal to or less than minus 20° C.

The atmosphere in which the UV light is applied is preferably an inert gas atmosphere such as nitrogen or argon atmosphere. As such, the bonding film 3 can be prevented from being degenerated or deteriorated by being oxidized by application of the UV light.

Thus, by appropriately controlling the atmosphere for applying the UV light as described above, the refractive index of the bonding film 3 finally obtained can be adjusted to an intended value with high precision.

Regarding adjustment of the refractive index of the bonding film 3, the adjustment of the refractive index appropriately in accordance with the refractive index of the base member 2 or of the object to be bonded 4 as described above allows production of an optical component exhibiting high optical performance.

For example, when the base member 2 is made of a light-transmitting material, the refractive index of the bonding film 3 may be adjusted so as to be approximately the same as a refractive index of the light-transmitting material to thereby improve optical transmittance between the base member 2 and the bonding film 3.

Preferably, the light-transmitting material is quartz glass or quartz crystal. Those materials are highly light-transmissive and thus are suitably used as optical component materials. Furthermore, the refractive index of the bonding film 3 is relatively close to that of quartz glass or quartz crystal. Accordingly, for example, when producing a laminated optical element by bonding optical components made of quartz crystal to each other, the refractive index of the bonding film 3 may be adjusted so as to be approximately the same as a refractive index of quartz crystal, thereby facilitating production of a laminated optical element having high optical transmittance.

When select leaving groups 303 are separated by applying the UV light to the bonding film 3, the refractive index of the bonding film 3 is changed and active bonds occur on a surface 35 of and an inside of the bonding film 3. Thereby, the surface 35 of the bonding film 3 becomes adhesive to the object to be bonded 4. As a result, the bonding film 3 can be strongly bonded to the object to be bonded 4 based on a chemical bonding.

As shown in FIG. 3, before application of the UV light, the bonding film 3 has the Si skeleton 301 and leaving groups 303. Due to application of energy to the bonding film 3, some leaving groups 303 (methyl groups in the present embodiment) are eliminated from the Si skeleton 301. Thereby, as shown in FIG. 4, an active bond 304 occurs at the surface 35 of the bonding film 3 to allow activation of the bonding film 3, so that the surface 35 of the bonding film 3 becomes adhesive.

In this case, “activation” of the bonding film 3 means a condition where the leaving groups 303 at the surface 35 (and to some extent toward the inside of the bonding film 3) are eliminated and thereby a non-terminated bond (hereinafter referred to as “broken bond” or “dangling bond”) occurs in the Si skeleton 301, a condition where the broken bond has a hydroxyl group (an OH group) at an end thereof; or a condition where those conditions occur together.

Thus, the active bond 304 is referred to as a broken bond (a dangling bond) or a broken bond having an OH group at an end thereof. By using the active bond 304, particularly strong bonding can be achieved between the bonding film 3 and the object to be bonded 4.

Adhesion occurring in the bonding film 3 varies depending on a density of a bond generated in the bonding film 3. In other words, the adhesion of the bonding film 3 is changed in accordance with conditions for application of the UV light to the bonding film 3, such as the wavelength of and the accumulated amount of the UV light applied.

Accordingly, although a certain degree of adhesion occurs in the bonding film 3 formed through the present step, the level of the adhesion is not constant. Therefore, in order to allow the bonding film 3 to have stable adhesion, it is preferable to expose the bonding film 3 to plasma after application of the UV light Hereinafter, a description of exposing the bonding film 3 to plasma will be provided.

3. Next, as shown in FIG. 1C, the surface 35 of the bonding film 3 is exposed to plasma (a plasma treatment step).

At the surface 35 of the bonding film 3 exposed to plasma, the leaving groups 303 are eliminated from the Si skeleton 301. After elimination of these leaving groups 303, an active bond occurs, so that the surface 35 of the bonding film 3 becomes stably adhesive to the object to be bonded 4. As a result, the bonding film 3 can be strongly and stably bonded to the object to be bonded 4 based on the chemical bonding.

In this manner, with exposure to the plasma, plasma selectively acts at the surface 35 of the bonding film 3 and thereby the active bond occurs at the surface 35, whereas most of the leaving groups 303 inside the boding film 3 remain in tact. Consequently, without hardly any change in the refractive index of the bonding film 3, the bonding film 3 can obtain stable adhesion properties.

Preferably, the bonding film 3 is exposed to atmospheric plasma. Using atmospheric plasma can facilitate plasma treatment, without any expensive equipment such as a pressure reducing unit. Other preferable examples of the plasma treatment include a direct plasma method generating plasma near the bonding film 3, a remote plasma method setting such that a target object to be plasma-treated is remote from a plasma generating section, and a down-flow plasma method. In the direct plasma method, since plasma is generated near the bonding film 3, plasma treatment can be efficiently and evenly performed. In addition, when the target object and the plasma generating section are remote from each other, there is no interference between the target object and the plasma generating section, thereby preventing the target object from being damaged by plasma ions.

When the plasma treatment is performed in a pressure-reduced atmosphere, gas unintentionally trapped in the bonding film 3, gas occurring over time, or the like can be forcibly drawn out of the bonding film 3. Such a phenomenon causes damage to the bonding film 3, thereby reducing adhesion and optical performance.

In contrast, performing the plasma treatment under atmospheric pressure can prevent damage to the bonding film 3, so that the bonding film 3 can obtain high adhesion properties and high optical performance.

Examples of plasma generating gas include Ar, He, H₂, N₂, O₂, and a mixture of at least two kinds thereof. Among these, in consideration of the oxidization of the bonding film 3 and the like, preferably, an inert gas such as Ar is used.

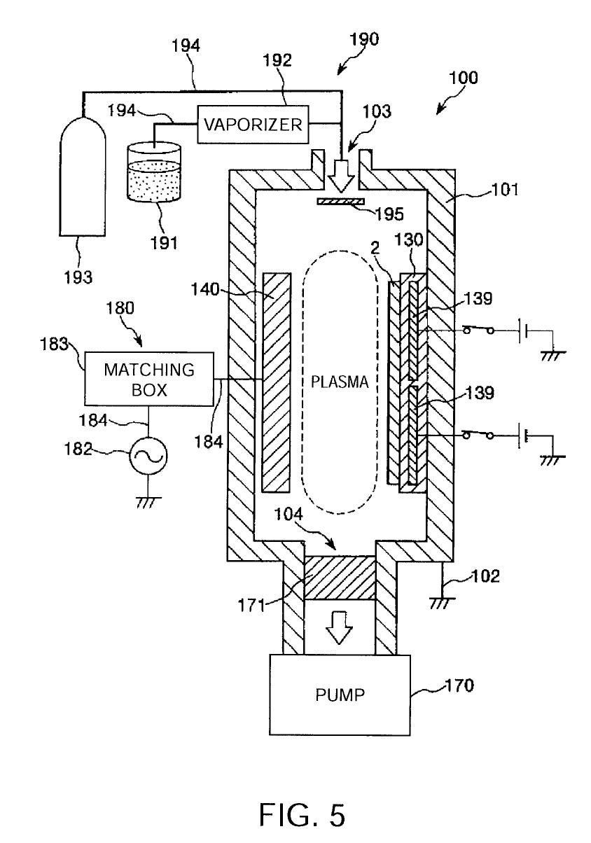

The plasma treatment may be performed by using a plasma polymerization apparatus 100 shown in FIG. 5 described later. Specifically, after forming the bonding film 3 by the plasma polymerization apparatus 100 of FIG. 5, the plasma treatment of the present step can be performed sequentially, without it being necessary to remove it from the apparatus 100. This can simplify the bonding method of the embodiment.

4. Next, as shown in FIG. 1D, the base member 2 and the object to be bonded 4 are bonded to each other such that the activated bonding film 3 is closely adhered to the object to be bonded 4. As a result, the bonded structure 5 can be obtained as shown in FIG. 2E (step 4).

The bonded structure 5 obtained in the above manner does not use adhesion mainly based on a physical bonding such as an anchor effect, like an adhesive used in the conventional bonding method. Instead, a strong chemical bond occurs in a short time, such as a covalent bond, to bond together the base member 2 and the object to be bonded 4 via the bonding film 3. Thus, the bonded structure 5 can be formed in a short time, and separation of the base member 2 and the object to be bonded 4 extremely rarely occurs and bonding unevenness and the like hardly occur.

Furthermore, in the bonding method of the embodiment, it is unnecessary to perform thermal treatment at high temperature (e.g. 700° C. or higher), as in conventional solid-to-solid bonding. Accordingly, the bonding method of the embodiment can achieve bonding between the base member 2 and the object to be bonded 4 even if each is made of a low heat-resistant material.

Still furthermore, since the base member 2 and the object to be bonded 4 are bonded together via the bonding film 3, there is an advantage in that the material of each of the base member 2 and the object to be bonded 4 is not specifically restricted.

Therefore, in the bonding method of the embodiment, various options are available to choose each material for the base member 2 and the object to be bonded 4.

In the present embodiment, the bonding film 3 is provided only on one of the base member 2 and the object to be bonded 4 that are to be bonded together (only on the base member 2 in the embodiment). In order to form the bonding film 3 on the base member 2, the base member 2 may be exposed to plasma for a relatively long time depending on a method for forming the bonding film 3, whereas the object to be bonded 4 is not exposed to plasma in the present embodiment. Thus, for example, even if the object to be bonded 4 has an extremely low durability to plasma, the embodiment can achieve strong bonding between the base member 2 and the object to be bonded 4. Therefore, there is another advantage that the material of the object to be bonded 4 can be chosen from a wide range of materials, with almost no consideration to resistance to plasma.

Now, a description will be given of a mechanism of bonding between the base member 2 and the object to be bonded 4 in the present step.

One example for describing the mechanism is a state where a hydroxyl group is exposed on a bonded surface of the object to be bonded 4. For example, in the present step, when the bonding film 3 is bonded to the object to be bonded 4 in such a manner that the surface 35 of the bonding film 3 contacts with the bonding surface of the object to be bonded 4, a hydroxyl group present at the surface 35 of the bonding film 3 and a hydroxyl group present at the bonding surface of the object to be bonded 4 pull against each other by hydrogen bonding, causing attraction between the hydroxyl groups. The attraction seems to serve to bond together the base member 2 and the object 4 to be bonded.

Depending on a temperature condition or the like, the hydroxyl groups pulling against each other by the hydrogen bonding are dehydrated and condensed. As a result, bonds bonded to the hydrogen groups are bonded to each other via an oxygen atom on a contact interface between the base member 2 and the object to be bonded 4. This seems to increase strength of the bonding between the base member 2 and the object to be bonded 4.

An activated condition of the surface of the bonding film 3 activated at the plasma treatment step is alleviated over time. Thus, preferably, step 3 is performed as immediately as possible after completion of the plasma treatment step. Specifically, step 3 is performed, preferably, within 60 minutes after the plasma treatment step, and more preferably within five minutes after the plasma treatment step. The surface 35 of the bonding film 3 maintains a sufficiently activated condition within the time. Accordingly, at the present step, when the base member 2 and the object to be bonded 4 are bonded together, the bonding between the constituent members 2 and 4 can be made sufficiently strong.

In other words, the bonding film 3 before activation has the Si skeleton 301, so that the bonding film 3 is chemically relatively stable and highly environment-resistant. Thus, the bonding film 3 before being activated is suitable for long-term preservation. Accordingly, from a viewpoint of production efficiency of the bonded structure 5, it is effective to produce or purchase and preserve a large number of base members 2 with the bonding film 3 formed thereon, and then, perform the plasma treatment step on only necessary pieces of the base members 2 immediately before bonding the base member 2 and the object to be bonded 4 together at the present step.

In the manner described above, there can be obtained the bonded structure 5, as shown in FIG. 2E.

In FIG. 2E, the object to be bonded 4 is placed on the bonding film 3 so as to cover an entire surface of the bonding film 3. However, there may be deviation in relative positions between those members. For example, the object to be bonded 4 may protrude from an edge of the bonding film 3.

In the bonded structure 5 thus obtained, the bonding strength between the base member 2 and the object to be bonded 4 is preferably equal to or more than 5 MPa (50 kgf/cm²), and is more preferably equal to or more than 10 MPa (100 kgf/cm²). The bonded structure 5 having the bonding strength as above can sufficiently prevent separation of the base member 2 and the object to be bonded 4.

In addition, the bonded structure 5 obtained may include a protective layer made of a UV-shielding material in order to protect against UV-induced damage after production.

As some examples of the UV-shielding material, there may be mentioned zinc oxide, titanium oxide, cerium oxide, and iron oxide.

After obtaining the bonded structure 5, at least one of the following two steps 5A and 5B (as a step of increasing the bonding strength in the bonded structure 5) may be performed on the bonded structure 5. Thereby, the bonding strength in the bonded structure 5 can be further improved.

At step 5A, as shown in FIG. 2F, the bonded structure 5 obtained is pressurized in a direction in which the base member 2 and the object to be bonded 4 come close to each other.

Thereby, the respective surfaces of the bonding film 3 come closer to the corresponding surfaces of the base member 2 and the object to be bonded 4, thus increasing the bonding strength in the bonded structure 5.

In addition, with pressurization of the bonded structure 5, a space remaining between bonded interfaces in the bonded structure 5 can be crushed, so that a bonding area can be further increased. As a result, the bonding strength in the bonded structure 5 can be further increased.

Preferably, pressure applied to the bonded structure 5 is set to be as high as possible within a range not causing any damage to the bonded structure 5. This can increase the bonding strength in the bonded structure 5 in proportion to a magnitude of an applied pressure.

The pressure to be applied may be appropriately adjusted in accordance with conditions such as the material of each of the base member 2 and the object to be bonded 4, a thickness thereof, and a bonding device. Specifically, the pressure is preferably approximately 0.2 to 10 MPa and more preferably approximately 1 to 5 MPa, although the preferable pressure range varies to some extent depending on the material, the thickness, and the like of the base member 2 and the object to be bonded 4. Thereby, the bonding strength in the bonded structure 5 can be increased. Furthermore, the pressure to be applied may exceed an upper limit value of the above range, although damage or the like may be caused to the base member 2 and the object to be bonded 4 depending on the material thereof.

A pressurization time (duration) is not specifically restricted, but is preferably approximately 10 seconds to 30 minutes. The pressurization time may be appropriately changed in accordance with a pressure to be applied. Specifically, for example, by reducing the pressurization time along with an increase in the pressure to the bonded structure 5, the bonding strength in the bonded structure 5 can be improved.

At step 5B, as shown in FIG. 2F, the obtained bonded structure 5 is heated.

Heating can increase the bonding strength in the bonded structure 5.

In this case, the temperature for heating the bonded structure 5 is not restricted to a specific value as long as it is higher than room temperature and lower than a heat resistance temperature of the bonded structure 5. The heating temperature is preferably approximately 25 to 100° C. and more preferably approximately 50 to 100° C. Heating the bonded structure 5 within the above range can ensure that heat-induced degeneration or deterioration in the bonded structure 5 is prevented and the bonding strength is increased.

The heating time is not specifically restricted, but is preferably approximately 1 to 30 minutes.

When steps 5A and 5B are both performed, the steps are preferably simultaneously performed. In short, as shown in FIG. 2F, preferably, the bonded structure 5 is heated while being pressurized. This allows the pressurization effect and the heating effect to be synergistically exhibited, which particularly can increase the bonding strength in the bonded structure 5.

By going through the steps described above, a further increase in the bonding strength in the bonded structure 5 can be facilitated.

Next, details of the bonding film 3 will be described.

As described above, the bonding film 3 is formed by plasma polymerization. As shown in FIG. 3, the bonding film 3 includes the Si skeleton 301 including the siloxane (Si—O) bond 302 and having a random atomic structure and the leaving groups 303 bonding to the Si skeleton 301. The bonding film 3 thus formed becomes a strong film that is hardly deformed due to influence of the Si skeleton 301 including the siloxane (Si—O) bond 302 and having the random atomic structure. Since the Si skeleton 301 has low crystallization, defects such as displacement or deviation in a crystal grain boundary hardly occur. For this reason, the bonding film 3 can have high bonding strength, high chemical resistance, high light resistance, and high size precision. Accordingly, the bonded structure 5 finally obtained can also be excellent in bonding strength, chemical resistance, light resistance, and size precision.

When energy is applied to the bonding film 3 thus formed, some leaving groups 303 are eliminated from the Si skeleton 301, whereby active bonds 304 occur at the surface 35 of and inside of the bonding film 3, as shown in FIG. 4. Thereby, adhesion properties occur at the surface 35 of the bonding film 3. With the occurrence of the adhesion properties, the bonding film 3 can be strongly and efficiently bonded to the object to be bonded 4 with high size precision.

The bonding energy between the leaving groups 303 and the Si skeleton 301 is smaller than the bonding energy of the siloxane bond 302 in the Si skeleton 301. Accordingly, by applying energy to the bonding film 3, bonding between the leaving groups 303 and the Si skeleton 301 can be selectively cut to eliminate some leaving groups 303, while preventing destruction of the Si skeleton 301.

In addition, the bonding film 3 thus formed is a solid having no fluidity. Thus, as compared to conventional liquid or mucous adhesives having fluidity, the thickness and the shape of a bonding layer (the bonding film 3) are hardly changed. Thereby, the size precision of the bonded structure 5 is much higher than in the conventional bonded structure. Furthermore, the time for curing an adhesive is not required, so that strong bonding can be achieved in a short time.

In the bonding film 3, particularly, regarding atoms obtained by removing H atoms from all atoms composing the bonding film 3, a sum of a content of Si atoms and a content of O atoms ranges from preferably approximately 10 to 90 atom percent, and more preferably approximately 20 to 80 atom percent. When the total content of the Si atoms and the O atoms is in the above range, the bonding film 3 includes a strong network of the Si atoms and the O atoms, whereby the bonding film 3 becomes strong. Additionally, the bonding film 3 thus formed exhibits particularly high bonding strength when bonded to each of the base member 2 and the object to be bonded 4.

The ratio of the Si atoms and the O atoms included in the bonding film 3 ranges from preferably approximately 3:7 to 7:3, and more preferably approximately 4:6 to 6:4. Setting the ratio of the Si atoms and the O atoms in the above range can increase stability of the bonding film 3, thereby further increasing the bonding between the base member 2 and the object to be bonded 4.

The degree of crystallization of the Si skeleton 301 is preferably equal to or less than 45% and more preferably equal to or less than 40%. This allows the Si skeleton 301 to have a sufficiently random atomic structure. Consequently, the characteristics of the Si skeleton 301 mentioned above become apparent, whereby the bonding film 3 has higher size precision and higher adhesion properties.

The degree of crystallization of the Si skeleton 301 can be measured by a general crystallization measuring method. Specifically, examples of methods for measuring the crystallization thereof include a measuring method based on intensity of a scattered X-ray in a crystallized portion (an X-ray method), a method for measuring based on strength of a crystallization band of infrared absorption (an infrared ray method), a method for measuring based on an area below a differential curve of a nuclear magnetic resonance absorption (a nuclear magnetic resonance absorption method), and a chemical method using a fact that chemical reagents hardly infiltrate in any crystallized portion.

Additionally, preferably, the bonding film 3 includes an Si—H bond in its structure. The Si—H bond occurs in a polymer in polymerization reaction of silane caused by a plasma polymerization method. In this case, the Si—H bond seems to inhibit a siloxane bond from being regularly generated. Thereby, the siloxane bond is formed so as to avoid the Si—H bond, thus reducing regularity of the atomic structure of the Si skeleton 301. In this manner, using plasma polymerization, the Si skeleton 301 having low crystallization can be efficiently formed.

Meanwhile, the crystallization of the Si skeleton 301 is not reduced even if the content of the Si—H bond included in the bonding film 3 is increased. Specifically, in an infrared absorption spectrum of the bonding film 3, when a peak intensity of the siloxane bond is set to 1, a peak intensity of the Si—H bond ranges from preferably approximately 0.001 to 0.2, more preferably approximately 0.002 to 0.05, and still more preferably approximately 0.005 to 0.02. Setting a ratio of the Si—H bond to the siloxane bond in the above range allows the atomic structure in the bonding film 3 to become most random relatively to the ratio. Thus, when the peak intensity of the Si—H bond with respect to the peak intensity of the siloxane bond is within the above range, the bonding film 3 can be particularly excellent in bonding strength, chemical resistance, and size precision.

As described above, the leaving groups 303 bonded to the Si skeleton 301 acts so as to cause generation of active bonds in the bonding film 3 by selective elimination from the Si skeleton 301. Accordingly, the leaving groups 303 need to be surely bonded to the Si skeleton 301 so as not to be eliminated therefrom when no energy is applied, whereas the leaving groups 303 are eliminated relatively easily and evenly when energy is applied.

In forming the bonding film 3 using plasma polymerization, polymerization reaction of a component of a raw material gas results in generation of the Si skeleton 301 including the siloxane bond and a residue bonded to the siloxane bond 301. The residue may be the leaving groups 303, for example.

Preferably, the leaving groups 303 may include at least one kind of atom selected from hydrogen, boron, carbon, nitrogen, oxygen, phosphorous, sulphur, and halogen atoms, and an atomic group including the respective atoms located so as to be bonded to the Si skeleton 301. The leaving groups 303 are relatively excellent in selectivity of binding/leaving by application of energy. Thus, the leaving groups 303 as above can sufficiently satisfy the needs as described above, thereby further improving the adhesion properties of the bonding film 3.

Examples of the atomic group (groups) including the respective atoms located so as to be bonded to the Si skeleton 301 include an alkyl group such as a methyl group or an ethyl group, an alkenyl group such as a vinyl group or an allyl group, an aldehyde group, a ketone group, a carboxyl group, an amino group, an amide group, a nitro group, a halogen-substituted alkyl group, a mercapto group, a sulfonic acid group, a cyano group, and an isocyanate group.

Among the groups, particularly, the leaving groups 303 may include alkyl groups. The alkyl group is chemically stable, so that the bonding film 3 including the alkyl-group exhibits high environment resistance and high chemical resistance.

When the leaving groups 303 include methyl groups (—CH₃), a preferable content of the methyl groups is determined as below, based on peak intensity in the infrared absorption spectrum.

Specifically, in the infrared absorption spectrum of the bonding film 3, when a peak intensity of the siloxane bond is set to 1, a peak intensity of the methyl groups ranges from preferably approximately 0.05 to 0.45, more preferably approximately 0.1 to 0.4, and still more preferably approximately 0.2 to 0.3. By setting a ratio of the peak intensity of the methyl groups to the peak intensity of the siloxane bond in the above range, the methyl group is prevented from inhibiting the generation of the siloxane bond more than necessary, as well as a necessary and sufficient number of active bonds are generated in the bonding film 3, thereby allowing sufficient adhesion properties to occur in the bonding film 3. In addition, the bonding film 3 exhibits sufficient environmental resistance and chemical resistance attributed to the methyl groups.

As the material of the bonding film 3 having characteristics described above, for example, there may be mentioned a polymer including a siloxane bond such as polyorganosiloxane and an organic group as the leaving groups 303 bonded to the siloxane bond.

The bonding film 3 made of polyorganosiloxane has excellent mechanical characteristics. In addition, the bonding film 3 exhibits particularly high adhesion to many materials. Accordingly, the bonding film 3 made of polyorganosiloxane is particularly strongly adhered to both of the base member 2 and the object to be bonded 4. As a result, using the bonding film 3 allows strong bonding between the base member 2 and the object to be bonded 4.

Polyorganosiloxane, which usually exhibits hydrophobic (non-adhesive) properties, allows an organic group to be easily eliminated by application of energy, so that polyorganosiloxane is changed to be hydrophilic so as to exhibit adhesive properties. Thus, polyorganosiloxane has an advantage that control of non-adhesion and adhesion can be easily and surely performed.

The hydrophobic (non-adhesive) properties occur mainly due to an effect of an alkyl group included in polyorganosiloxane. Accordingly, using the bonding film 3 made of polyorganosiloxane is advantageous in that application of energy allows adhesive properties to occur at the surface 35, as well as allows a region of the film except for along the surface 35 to exhibit the effect and the advantage of the alkyl group described above. Thereby, the bonding film 3 thus formed has high environmental resistance and high chemical resistance, and for example, is effectively used to form optical elements or liquid droplet discharging heads exposed to chemicals or the like for a long period of time.

Particularly among various kinds of polyorganosiloxanes, preferably, a polymer of octamethyltrisiloxane is predominately contained in the bonding film 3. The bonding film 3 predominantly made of a polymer of octamethyltrisiloxane has particularly high adhesion properties. In addition, a material containing octamethyltrisiloxane as a main component is in liquid form at room temperature and has moderate viscosity. Thus, there is an advantage that the material can be easily used.

A mean thickness of the bonding film 3 is preferably 1 to 1000 nm and more preferably 2 to 800 nm. By using the bonding film having a mean thickness set in the above range, the size precision of the bonded structure 5 is not significantly reduced, but the bonding strength in the bonded structure 5 can be further increased.

Conversely, when the mean thickness of the bonding film 3 is below the lowest limit value of the range, the bonding strength may be insufficient. Meanwhile, when the bonding film 3 has a mean thickness above the upper limit value of the range, the size precision of the bonded structure 5 may be reduced.

Furthermore, the bonding film 3 having the mean thickness set in the above range maintains a certain degree of shape followability. Accordingly, for example, even if the bonding surface of the base member 2 (the surface facing the bonding film 3) has an uneven portion, the bonding film 3 can be adhered so as to follow a shape of the uneven portion, although it depends on the height of the uneven portion. As a result, the bonding film 3 covers unevenness of the portion, thereby reducing the height of the uneven portion formed on the surface of the film. Then, when the base member 2 is adhered to the object to be bonded 4, adhesiveness between the base member 2 and the object to be bonded 4 can be increased.

The degree of the shape followability as mentioned above becomes more apparent as the thickness of the bonding film 3 is increased. Thus, in order to ensure sufficient shape followability, the thickness of the bonding film 3 may be made as large as possible.

Hereinabove, the details of the bonding film 3 have been described. The bonding film 3 described above is formed by plasma polymerization, which serves to efficiently produce the bonding film 3 as an elaborate and homogeneous film. Thereby, the bonding film 3 and the object to be bonded 4 can be particularly strongly bonded together. In addition, the bonding film 3 produced by plasma polymerization maintains the state activated by application of energy for a relatively long time. This can simplify a production process of the bonded structure 5 to make the production process more efficient.

Next, a method for forming the bonding film 3 will be described below.

First, before describing the bonding film forming method, a plasma polymerizing apparatus will be described. The plasma polymerizing apparatus is used to form the bonding film 3 on the base member 2 by using plasma polymerization.

FIG. 5 is a longitudinal section view schematically showing the plasma polymerizing apparatus used in the bonding method of the embodiment. In the description below, upper and lower sides, respectively, in FIG. 5, will be referred to as “top” and “bottom”, respectively.

A plasma polymerizing apparatus 100 shown in FIG. 5 includes a chamber 101, a first electrode 130 supporting the base member 2, a second electrode 140, a power supply circuit 180 applying a high frequency voltage between the electrodes 130 and 140, a gas supplying section 190 supplying gas into the chamber 101, and an emission pump 170 emitting the gas present in the chamber 101. Among those components, the first and the second electrodes 130 and 140 are provided inside the chamber 101. Each of the components will be described in detail below.

The chamber 101 is a container that can maintain the air tightness of an inside of the chamber and is used in a condition where a pressure inside the chamber is reduced (namely, in a vacuum condition). Thereby, the chamber 101 can have a pressure-tolerant capability high enough to be durable against a pressure difference between the inside of and the outside of the chamber.

The chamber 101 shown in FIG. 5 includes a chamber main body having an approximately cylindrical shape whose axial line is arranged in a horizontal direction, a circular side wall sealing a left opening portion of the chamber main body, and a circular side wall sealing a right opening portion thereof.

At a top of the chamber 101 is provided a supply outlet 103 and at a bottom thereof is provided an emission outlet 104. The supply outlet 103 is connected to a gas supplying section 190, and the emission outlet 104 is connected to the emission pump 170.

In the present embodiment, the chamber 101 is made of a highly conductive metal and is electrically grounded via a ground line 102.

The first electrode 130 has a plate shape and supports the base member 2.

The first electrode 130 is vertically provided on an inner wall surface of one of the side walls of the chamber 101 to be electrically grounded via the chamber 101. As shown in FIG. 5, the first electrode 130 is arranged concentrically with respect to the chamber main body.

On a surface of the first electrode 130 supporting the base member 2 is an electrostatic chuck (an adsorption mechanism) 139.

The electrostatic chuck 139 allows the base member 2 to be vertically supported, as shown in FIG. 5. Even if some warpage occurs on the base member 2, the base member 2 adsorbed by the electrostatic chuck can be subjected to plasma treatment in a condition where the warpage has been corrected.

The second electrode 140 is provided facing the first electrode 130 via the base member 2. The second electrode 140 is spaced apart (insulated) from an inner wall surface of the other side wall of the chamber 101.

The second electrode 140 is connected to a high frequency power supply 182 via a wiring 184. At a predetermined point of the wiring 184 is provided a matching box (a matching unit) 183. The wiring 184, the high frequency power supply 182, and the matching box 183 form a power supply circuit 180.

In the power supply circuit 180, the first electrode 130 is grounded. Thus, a high frequency electric voltage is applied between the first and the second electrodes 130 and 140. Thereby, an electric field is induced in a space between the first and the second electrodes 130 and 140. A direction of the electric field is reversed at high frequency.

The gas supplying section 190 supplies a predetermined gas into the chamber 101.

The gas supplying section 190 shown in FIG. 5 includes a reservoir section 191 storing a liquid film material (a raw liquid), a vaporizer 192 vaporizing the liquid film material to change the material into a gas, and a gas cylinder 193 storing a carrier gas. Those components are connected to the supply outlet 103 of the chamber 101 via the pipe 194 such that a mixture gas of a gaseous film material (a raw gas) and the carrier gas is supplied from the supply outlet 103 into the chamber 101.

The liquid film material stored in the reservoir section 191 is a raw material used to form a polymerization film on the surface of the base member 2 by performing polymerization using the plasma polymerization apparatus 100.

The liquid film material is vaporized by the vaporizer 192 to be changed into the gaseous film material (the raw gas) and supplied into the chamber 101. The raw gas will be described in detail later.

The carrier gas stored in the gas cylinder 193 is a gas introduced to cause discharge due to effect of an electric field and maintain the discharge. The carrier gas may be an Ar gas or a He gas, for example.

Near the supply outlet 103 in the chamber 101 is disposed a diffusion plate 195.

The diffusion plate 195 serves to promote diffusion of the mixture gas supplied in the chamber 101, whereby the mixture gas can be diffused with an approximately even concentration in the chamber 101.

The emission pump 170 emits air present in the chamber 101. For example, the emission pump 170 may be an oil-sealed rotary pump or a turbo-molecular pump. In this manner, emitting air from the chamber 101 to reduce pressure thereinside can facilitate plasmatization of an introduced gas. In addition, contamination, oxidization, or the like of the base member 2 caused by contact with the air can be prevented, as well as a reaction product formed by plasma treatment can be effectively removed from the chamber 101.

Furthermore, the emission outlet 104 has a pressure control mechanism 171 adjusting pressure in the chamber 101. Thereby, the pressure inside the chamber 101 can be appropriately set in accordance with an operation status of the gas supplying section 190.

Next the method for forming the bonding film 3 on the base member 2 by the plasma polymerization apparatus 100 will be described.

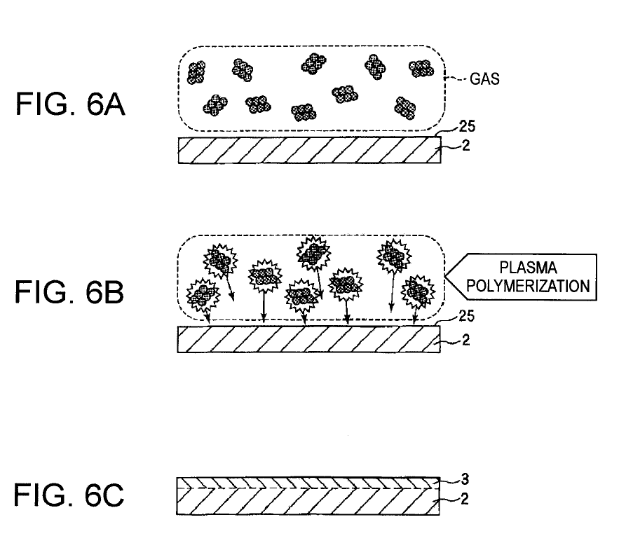

FIGS. 6A, 6B, and 6C are longitudinal sectional views illustrating the method for forming the bonding film 3 on the base member 2. In the description below, upper and lower sides, respectively, in the drawings will be referred to as “top” and “bottom”, respectively.

In order to obtain the bonding film 3, the mixture gas of a raw gas and a carrier gas is supplied into a strong electric field to cause polymerization of molecules in the raw gas so as to allow deposition of a polymer on the base member 2. Details of the production process will be described below.

First, the base member 2 is prepared. If desired, a surface treatment as described above is performed on a top surface 25 of the base member 2.

Next, the base member 2 is placed in the chamber 101 of the plasma polymerization apparatus 100 in a sealed condition. Then, with operation of the emission pump 170, pressure in the chamber 101 is reduced.

Next, the gas supplying section 190 is operated to supply the mixture gas of a raw gas and a carrier gas into the chamber 101. The supplied mixture gas is filled in the chamber 101 (See FIG. 6A).

In this case, a ratio of the raw gas included in the mixture gas (a mixture ratio) slightly varies depending on kinds of the raw gas and the carrier gas, an intended speed of film formation, and the like. For example, the ratio of the raw gas in the mixture gas is set in a range preferably approximately from 20 to 70% and more preferably approximately from 30 to 60%. Thereby, conditions for formation of the polymerized film (film-formation conditions) can be selected.

A flow rate of gas supplied is appropriately determined by the kind of gas, an intended speed of film formation, a film thickness, and the like and is not specifically restricted. Usually, the flow rate of each of a raw gas and a carrier gas is set in a range of preferably approximately 1 to 100 ccm and more preferably approximately 10 to 60 ccm.

Next, the power supply circuit 180 is operated to apply a high frequency voltage between the pair of electrodes 130 and 140. Thereby, molecules of gas present between the electrodes 130 and 140 are ionized, leading to generation of plasma. Energy of the plasma generated causes polymerization of the molecules included in a raw gas, whereby a polymer of the raw gas is adhered and deposited, as shown in FIG. 6B. As a result, on the base member 2 is formed the bonding film 3 made of the plasma-polymerized film (See FIG. 6C).

In addition, due to an effect of plasma, the surface of the base member 2 is activated and cleaned. This facilitates deposition of the polymer of the raw gas on the surface of the base member 2, resulting in stable formation of the bonding film 3. In this manner, plasma polymerization allows adhesive strength between the base member 2 and the bonding film 3 to be further increased regardless of the material of the base member 2.

Examples of the raw gas include organosiloxanes such as methylsiloxane, octamethyltrisiloxane, decamethyltetrasiloxane, decamethylcyclopentasiloxane, octamethylcyclotetrasiloxane, and methylphenylsiloxane.

The plasma-polymerized film obtained using such a raw gas, namely, the bonding film 3 is made of a polymer obtained by polymerization of the raw material, namely, polyorganosiloxane.

In plasma polymerization, a frequency of the high frequency applied between the pair of electrodes 130 and 140 is not specifically restricted, but ranges preferably approximately 1 kHz to 100 MHz and more preferably approximately 10 to 60 MHz.

High frequency output density is not specifically restricted, but ranges preferably approximately 0.01 to 100 W/cm², more preferably approximately 0.1 to 50 W/cm², and still more preferably approximately 1 to 40 W/cm². By setting the high frequency output density in the above range, it can be prevented that too high density of the high frequency output leads to application of a more-than-necessary amount of plasma energy to the raw gas, as well as the Si skeleton 301 having the random atomic structure can be surely formed. When the high frequency output density is below the lower limit value of the range, the molecules in the raw gas cannot be polymerized, and thus, formation of the bonding film 3 may be impossible. Conversely, in case of the high frequency output density exceeding the upper limit value of the range, decomposition of the rag gas or the like occurs, and thereby, a structure capable of being the leaving group 303 is separated from the Si skeleton 301. As a result, a content of the leaving group 303 in the bonding film 3 obtained may be reduced, or randomness of the Si skeleton 301 may be reduced (regularity of the skeleton may be increased).

Pressure in the chamber 101 upon formation of the bonding film 3 ranges from preferably approximately 133.3×10⁻⁵ to 1333 Pa (1×10⁻⁵ to 10 Torr), and more preferably approximately 133.3×10⁻⁴ to 133.3 Pa (1×10⁻⁴ to 1 Torr). This further ensures that the bonding film 3 can be molten at lower temperature.

The flow rate of the raw gas ranges preferably approximately 0.5 to 200 sccm, and more preferably approximately 1 to 100 sccm. Meanwhile, the flow rate of the carrier gas ranges preferably approximately 5 to 750 sccm, and more preferably approximately 10 to 500 sccm.

The treatment time is preferably approximately 1 to 10 minutes, and more preferably approximately 4 to 7 minutes.

The temperature of the base member 2 is preferably equal to or higher than 25° C. and is more preferably approximately 25 to 100° C.

In the conditions described above, the bonding film 3 can be obtained.

Although the bonding film 3 can transmit light, the refractive index of the bonding film 3 can be adjusted in a range of 1.35 to 1.6. The bonding film 3 thus formed has a refractive index close to a refractive index of quartz crystal or quartz glass, and thus, is suitably used to produce optical components structured such that an optical path passes through the bonding film 3, as described above.

In addition, the bonding film 3 has a thermal expansion rate close to that of each of quartz crystal and quartz glass, so that there is a small thermal expansion rate difference between the bonding film 3 and the base member 2 made of quartz crystal or quartz glass, thereby enabling post-bonding deformation to be suppressed.

### Second Embodiment

Next, a bonding method according to a second embodiment will be described.

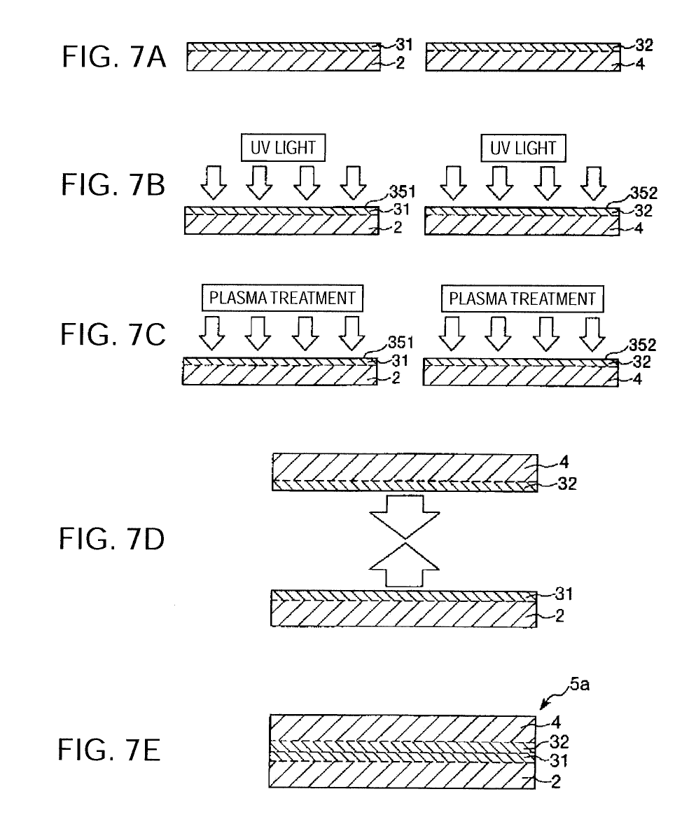

FIGS. 7A to 7E are longitudinal sectional views illustrating the bonding method of the second embodiment. In the description below, upper and lower sides, respectively, in FIGS. 7A to 7E, will be referred to as “top” and “bottom”, respectively.

Hereinafter, the description of the bonding method of the second embodiment will focus on points that are different from the first embodiment, whereas descriptions of the same points as in the first embodiment will be omitted.

The bonding method of the second embodiment is the same as the first embodiment excepting that a bonding film is formed on a surface of each of the base member 2 and the object to be bonded 4 to bond together the base member 2 and the object to be bonded 4 such that the bonding films are closely adhered to each other.

Specifically, the bonding method of the second embodiment includes preparing the base member 2 and the object to be bonded 4 to form a bonding film 31 on a surface of the base member 2 and a bonding film 32 on a surface of the object to be bonded 4; applying a predetermined accumulated amount of UV light to each of the bonding films 31 and 32 to obtain the bonding films 31 and 32 having a predetermined refractive index; exposing the bonding films 31 and 32 to plasma; and bonding the base member 2 and the object to be bonded 4 together such that the bonding films 31 and 32 are closely adhered to each other to obtain a bonded structure 5a. Hereinafter, the steps of the bonding method of the second embodiment will be sequentially described.

1. First, as in the first embodiment, the base member 2 and the object to be bonded 4 are prepared. Then, the bonding films 31 and 32, respectively, are formed on the surfaces of the base member 2 and the object to be bonded 4, respectively by plasma polymerization (See FIG. 7A).

2. Next, as shown in FIG. 7B, a predetermined accumulated amount of LTV light is applied to each of the bonding films 31 and 32. By application of the UV light to the bonding films 31 and 32, a refractive index of each of the bonding films 31 and 32 is adjusted, whereby each of the bonding films 31 and 32 can have a predetermined refractive index.

The conditions for application of the UV light are the same as those in the first embodiment.

In that case, similarly to what has been stated above, “activation” of the bonding films 31 and 32 indicates a condition where the leaving group 303 on surfaces 351 and 352 of the bonding films 31 and 32 and inside each of the films is eliminated and thereby a non-terminated bond (a dangling bond) occurs in the Si skeleton 301, a condition where the dangling bond has a hydroxyl group (an OH group) at an end thereof; or a condition where those conditions are present together.

Accordingly, the active bond 304 is referred to as a dangling bond or a dangling bond having an OH group at an end thereof.

3. Next, as shown in FIG. 7C, the surfaces 351 and 352 of the bonding films 31 and 32 are exposed to plasma.

When exposed to plasma, the surfaces 351 and 352 thereof have adhesive properties.

4. Then, as shown in FIG. 7D, the bonding films 31 and 32 having the adhesive properties are bonded together so as to be closely adhered to each other, thereby obtaining the bonded structure 5a.

In the present step, the bonding films 31 and 32 are bonded together. The bonding between the films 31 and 32 seems to be based on at least one of following two mechanisms I and II:

I. For example, a description is given of a case in which an OH group is exposed on each of the surfaces 351 and 352 of the bonding films 31 and 32. In the present step, when the base member 2 is bonded to the object to be bonded 4 such that the bonding films 31 and 32 are closely adhered to each other, the OH groups on the surfaces 351 and 352 of the bonding films 31 and 32 pull against each other by hydrogen bonding, thereby causing attraction between the OH groups. It seems that the attraction serves to bond the base member 2 to the object to be bonded 4.

The OH groups pulling against each other by the hydrogen bonding are dehydrated and condensed depending on a temperature condition or the like. As a result, between the bonding films 31 and 32, bonds bonded to the OH groups are bonded to each other via an oxygen atom. Thereby, the base member 2 and the object to be bonded 4 seem to be more strongly bonded together.

II. When the base member 2 and the object to be bonded 4 are bonded together such that the bonding films 31 and 32 are closely adhered to each other, non-terminated bonds (dangling bonds) occurring at the surfaces 351 and 352 of the bonding films 31 and 32 and inside the films are re-bonded to each other. The rebinding between the dangling bonds occur in a complicated manner so as to be overlapped with each other (entangled with each other), thereby forming a network binding on a bonded interface between the films. As a result, base materials (the Si skeletons 301) of the bonding films 31 and 32 are directly bonded to each other, so that the bonding films 31 and 32 are integrated with each other.

With at least one of the mechanisms I and II, the bonded structure 5a as in FIG. 7E can be obtained.

### Third Embodiment

Next, a bonding method according to a third embodiment will be described.

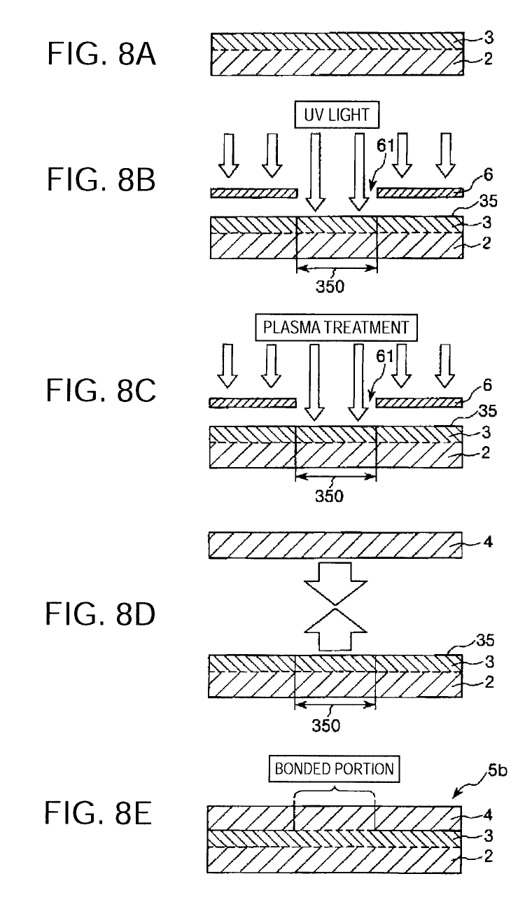

FIGS. 8A to 8E are longitudinal sectional views illustrating the bonding method of the third embodiment. In the description below, upper and lower sides, respectively, in FIGS. 8A to 8E, will be referred to as “top” and “bottom”, respectively.

Hereinafter, the description of the bonding method of the third embodiment will focus on points that are different from the first and the second embodiments, whereas descriptions of the same points as in the first and the second embodiments will be omitted.

The bonding method of the third embodiment is the same as the first embodiment excepting that a refractive index is selectively adjusted for only a predetermined region 350 of the bonding film 3 and only the predetermined region 350 is activated to (partially) bond the base member 2 and the object to be bonded 4 to each other at the predetermined region 350.

Specifically, the bonding method of the third embodiment includes preparing the base member 2 and the object to be bonded 4 to form the bonding film 3 on a surface of the base member 2 (step 1); applying a predetermined accumulated amount of UV light selectively to the predetermined region 350 of the bonding film 3 to obtain the bonding film 3 having a predetermined refractive index (step 2); exposing the bonding film 3 to plasma; and bonding together the base member 2 and the object to be bonded 4 such that the bonding film 3 is closely adhered to the object to be bonded 4 to obtain a bonded structure 5b (step 3). Hereinafter, the steps of the bonding method of the third embodiment will be sequentially described.

1. First, as in the first embodiment, the base member 2 and the object to be bonded 4 are prepared. Then, the bonding film 3 is formed on the surface of the base member 2 by plasma polymerization (See FIG. 8A).

2. Next, as shown in FIG. 8B, a predetermined accumulated amount of UV light is applied selectively to the predetermined region 350 of the surface 35 of the bonding film 3. By applying the UV light to the predetermined region 350 of the bonding film 3, the refractive index of the predetermined region 350 is adjusted, whereby the bonding film 3 obtained can have a predetermined refractive index.

Conditions for application of the UV light are the same as those in the first embodiment.

3. Next, as shown in FIG. 8C, on the surface 35 of the bonding film 3, the predetermined region 350 is selectively exposed to plasma. Exposure to plasma allows the surface 35 of the bonding film 3 to be stably adhesive to the object to be bonded 4. As a result, the bonding film 3 can be strongly and stably bonded to the object to be bonded 4 based on chemical bonding.

4. Next, as shown in FIG. 8D, the base member 2 and the object to be bonded 4 are bonded together such that the adhesive bonding film 3 is closely adhered to the object to be bonded 4, thereby obtain the bonded structure 5b as shown in FIG. 8E.

The bonded structure 5b thus formed is obtained not by bonding together the entire opposing surfaces of the base member 2 and the object to be bonded 4, but by bonding together only partial regions of the base member 2 and the object to be bonded 4 (regions corresponding to the predetermined region 350). In the bonding, by merely controlling the region of the bonding film 3 to be subjected to plasma exposure, a region to be bonded can be easily selected. Thereby, control of an area of the predetermined region 350 can facilitate adjustment of bonding strength in the bonded structure 5b. Consequently, for example, in the bonded structure 5b obtained, the bonded regions can be easily separated from each other.

In addition, appropriate control of the area and the shape of the bonded region (the predetermined region 350) between the base member 2 and the object to be bonded 4 shown in FIG. 8E can reduce local concentration of stress occurring on the bonded region. This can ensure that the base member 2 and the object to be bonded 4 are bonded to each other, even if there is a large thermal expansion difference between the base member 2 and the object to be bonded 4.

Furthermore, in the bonded structure 5b, between the bonding film 3 and the object to be bonded 4, a small space exists (remains) in a region other than the predetermined region 350 where the bonding film 3 and the object to be bonded 4 are bonded together. Accordingly, by controlling the shape of the predetermined region 350, an enclosed space, a flow path, or the like can be easily formed between the bonding film 3 and the object to be bonded 4.

Still furthermore, as a result of the selective application of UV light to the predetermined region 350, the refractive index differs between the predetermined region 350 and the region other than that on the bonding film 3. In other words, the bonding film 3 includes the regions having different refractive indexes.

The bonded structure 5b with the bonding film 3 thus formed can be suitably applied to optical elements or the like including a functional optical film that has regions with different refractive indexes.

In the present embodiment, on the bonding film 3, the region subjected to the application of UV light is the same as the region subjected to the exposure of plasma. However, the regions may be different from each other.

For example, after applying UV light to the predetermined region 350, an entire surface of the bonding film 3 may be exposed to plasma. In this case, adhesive properties occur on the entire surface of the bonding film 3, whereas the bonding film 3 includes partial regions with different refractive indexes. Accordingly, the bonding method of the embodiment is particularly useful to produce highly functional optical elements.

In the manner described above, there can be obtained the bonded structure 5b.

### Fourth Embodiment

Next, a bonding method according to a fourth embodiment will be described.

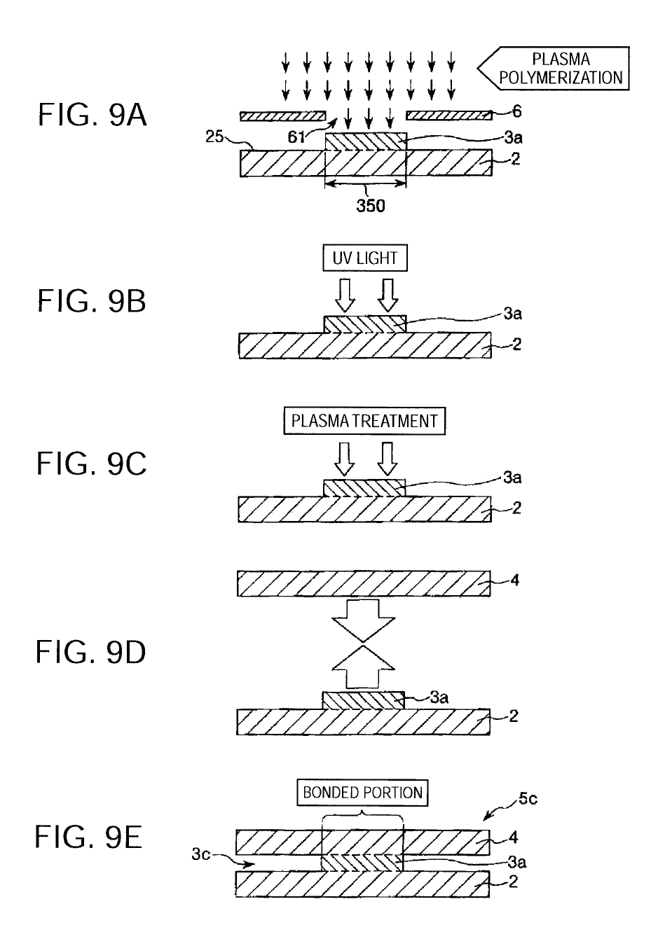

FIGS. 9A to 9E are longitudinal sectional views illustrating the bonding method of the fourth embodiment. In the description below, upper and lower sides, respectively, in FIGS. 9A to 9E, will be referred to as “top” and “bottom”, respectively.

Hereinafter, the description of the bonding method of the fourth embodiment will focus on points that are different from the first through the third embodiments, whereas descriptions of the same points as in the embodiments will be omitted.

The bonding method of the fourth embodiment is the same as the first embodiment excepting that a bonding film 3a is formed only on a region corresponding to the predetermined region 350 on the top surface 25 of the base member 2 to (partially) bond the base member 2 to the object to be bonded 4 at the predetermined region 350.

The bonding method of the fourth embodiment includes preparing the base member 2 and the object to be bonded 4 to form the bonding film 3a only on the region corresponding to the predetermined region 350 on the top surface 25 of the base member 2 (step 1); applying a predetermined accumulated amount of UV light to the bonding film 3a (step 2) to obtain the bonding film 3a having a predetermined refractive index; exposing the bonding film 3a to plasma; and bonding together the base member 2 and the object to be bonded 4 such that the bonding film 3a is closely adhered to the object to be bonded 4 to obtain a bonded structure 5c (step 3). Hereinafter, the steps of the bonding method of the fourth embodiment will be sequentially described.

1. First, as in the first embodiment, the base member 2 and the object to be bonded 4 are prepared. Then, the bonding film 3a is formed only on the region corresponding to the predetermined region 350 on the top surface 25 of the base member 2 (See FIG. 9A).

In order to form the bonding film 3a selectively on the predetermined region 350, as shown in FIG. 9A, a mask 6 is used that has a window portion 61 corresponding to the predetermined region 350. Through the mask 6, plasma polymerization may be performed to form a plasma-polymerized film.

2. Next, as shown in FIG. 9B, the predetermined accumulated amount of UV light is applied to the bonding film 3a. The application of UV light to the bonding film 3a allows adjustment of a refractive index of the bonding film 3a. Thereby, the bonding film 3a can obtain a predetermined refractive index.

Conditions for application of the UV light are the same as those in the first embodiment.

3. Next, as shown in FIG. 9C, the bonding film 3a is exposed to plasma. By exposing to plasma, the bonding film 3a obtains stable adhesion properties to the object to be bonded 4. As a result, the bonding film 3a can be stably and strongly bonded to the object to be bonded 4 based on chemical bonding.

4. Next, as shown in FIG. 9D, the base member 2 and the object to be bonded 4 are bonded together such that the adhesive bonding film 3a is closely adhered to the object to be bonded 4, thereby obtaining the bonded structure 5c shown in FIG. 9E.

The bonded structure 5c thus formed is obtained not by bonding together the entire opposing surfaces of the base member 2 and the object to be bonded 4, but by bonding together only partial regions of the base member 2 and the object to be bonded 4 (corresponding to the predetermined region 350). In formation of the bonding film 3a, by merely controlling the region for forming the bonding film 3a, a bonded region can be easily selected. Thereby, for example, controlling an area of the region (the predetermined region 350) for forming the bonding film 3a can facilitate adjustment of bonding strength in the bonded structure 5c. As a result, in the bonded structure 5c obtained, for example, the bonded regions can be easily separated from each other.

Additionally, appropriate control of the area and the shape of the bonded region (the predetermined region 350) between the base member 2 and the object to be bonded 4 shown in FIG. 8E can reduce local concentration of stress occurring on the bonded region. This can ensure that the base member 2 and the object to be bonded 4 are bonded to each other, even if there is a large thermal expansion difference between the base member 2 and the object to be bonded 4.

Furthermore, between the base member 2 and the object to be bonded 4 in the bonded structure 5c, on a region other than the predetermined region 350 is formed a space 3c of a distance corresponding to a thickness of the bonding film 3a (See FIG. 9E). Accordingly, by appropriately adjusting a shape of the predetermined region 350 and the thickness of the bonding film 3a, an enclosed space, a flow path, or the like having a desired shape can be easily formed between the base member 2 and the object to be bonded 4.

In the manner described above, there can be obtained the bonded structure 5c.

The bonding method according to each of the embodiments above can be used to bond various kinds of components to each other.

For example, such components may be semiconductor elements such as transistors, diodes, and memories, piezoelectric elements such as quartz crystal oscillators, optical elements such as reflectors, optical lenses, diffraction gratings, and optical filters, photoelectric conversion elements such as solar cells, components of micro electro mechanical systems (MEMS) such as semiconductor substrates with semiconductor elements mounted thereon, insulating substrates and wirings or electrodes, inkjet recording heads, micro reactors, and micro mirrors, sensor components such as pressure sensors and acceleration sensors, package components of semiconductor elements or electronic parts, storage media such as magnetic storage media, magneto-optical storage media, and optical storage media, display components such as liquid crystal display elements, organic EL elements, and electrophoretic display elements, or fuel cell components.

### Optical Elements

A description will be given of an optical element, obtained by applying any of the above bonded structures.

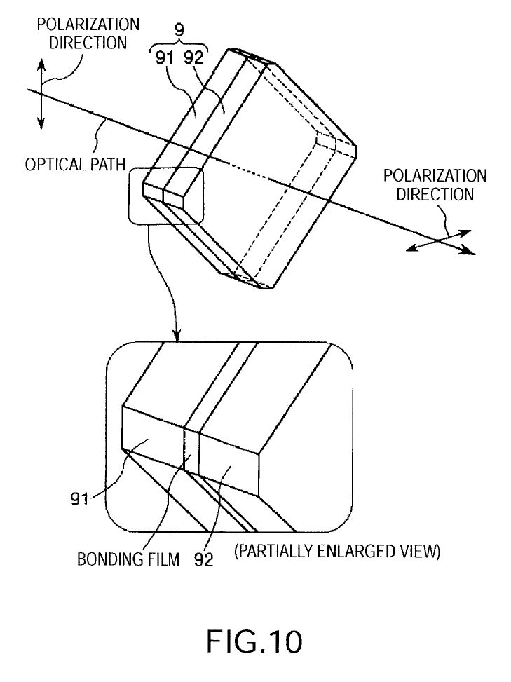

FIG. 10 is a perspective view of a wavelength plate (an example of the optical element of the embodiment) obtained by applying the bonded structure of one of the embodiments.

A wavelength plate 9 shown in FIG. 10 is “a one-half wavelength plate” providing a phase difference of a one-half wavelength to transmitted light. The wavelength plate 9 includes two birefringent crystal plates 91 and 92 that are adhered to each other in such a manner that optic axes of the two plates are orthogonal to each other. Examples of birefringent material include inorganic materials such as quartz crystal, calcite, MgF₂, YVO₄, TiO₂, and LiNbO₃ and organic materials such as polycarbonate.

When light is transmitted through the wavelength plate 9 thus structured, the light is split into a polarized component parallel to the optic axes and a polarized component vertical thereto. Phase of one of the components of the split light is delayed based on a refractive index difference due to birefringences of the crystal plates 91 and 92, thereby causing the phase difference mentioned above.

Precision of the phase difference provided to transmitted light by the wavelength plate 9 and transmittance of the wavelength plate 9 depend on precision of a plate thickness of each of the crystal plates 91 and 92. Thus, the thickness of each of the crystal plates 91 and 92 needs to be controlled with high precision.

In addition to that, a space between the crystal plates 91 and 92 has influence on the phase of transmitted light. Thus, a distance of the space between the crystal plates 91 and 92 needs to be strictly controlled, as well as both plates 91 and 92 need to be strongly bonded to each other so as to inhibit any change in the distance therebetween.

Thus, in the present embodiment, the bonded structure of one of the embodiments described above is applied to the wavelength plate 9, whereby there can be obtained the wavelength plate 9 including the crystal plates 91 and 92 strongly bonded to each other via a bonding film.

Additionally, the bonding film can be obtained by forming a film on a wide region at one time by plasma polymerization as a gas phase film formation method. Thus, the film can be formed evenly on the wide region and the film has a thickness with high precision. This can keep a high parallelism between the crystal plates 91 and 92, thereby obtaining the wavelength plate 9 with small aberration, such as small wave-surface aberration.

Furthermore, the bonding film is very thin and thus can suppress influence on light transmitted through the wavelength plate 9.

Still furthermore, in formation of the bonding film, by adjusting such that the refractive index of the bonding film is equal to a refractive index of the crystal plates 91 and 92, the bonding film 3 obtained can have a refractive index approximately equal to that of the crystal plates 91 and 92. Consequently, optical loss on a bonded interface between the crystal plates 91 and 92 is suppressed, so that the wavelength plate 9 obtained can have high optical transmittance.

Still furthermore, when each of the crystal plates 91 and 92 is made of quartz glass or quartz crystal, there is a small difference in thermal expansion rate between each of the plates 91 and 92 and the bonding film. This can suppress deformation of the wavelength plate 9 due to temperature change.

The wavelength plate 9 may be a one-quarter wavelength plate, a one-eighth wavelength plate, or the like, instead of the one-half wavelength plate.

As examples of the optical element, in addition to such a wavelength plate, there may be mentioned optical filters such as polarization filters, compound lenses such as optical pick-ups, prisms, diffraction gratings, and the like.

Hereinabove, the bonding method, the bonded structure, and the optical element according to each of the embodiments have been described with reference to the drawings. However, the invention is clearly not restricted to the embodiments above.

For example, a bonding method may be a combination with an arbitrary one method or arbitrary two or more methods selected from the embodiments described above.

Alternatively, the bonding method according to any of the embodiments may further include at least one arbitrarily intended step.

In addition, each of the embodiments above has described the method for bonding together the two base constituent members (the base member and the object to be bonded). However, the bonding method of each of the embodiments may be used to bond together three or more base constituent members to one another.

### EXAMPLES

Next, specific examples will be described.

1. Production of Bonded Structure

Hereinafter, a description will be given of Examples (Exs), a Reference Example (Ref-Ex), and a Comparative Example (Com-Ex), each of which produced a plurality of bonded structures.

### Example 1

First, a quartz crystal substrate was prepared for each of a base member and an object to be bonded. The quartz crystal substrate for the base member had a length of 20 mm, a width of 20 mm, and a mean thickness of 2 mm, and the quartz crystal substrate for the object to be bonded had a length of 20 mm, a width of 20 mm, and a mean thickness of 1 mm. The quartz crystal substrates were subjected to optical polishing. Each of the quartz crystal substrates had a refractive index of 1.554 with respect to light having a wavelength of 405 nm.

Then, the substrates were placed in the chamber 101 of the plasma polymerization apparatus 100 shown in FIG. 5 to perform surface treatment using oxygen plasma.

Next, on a surface of each substrate subjected to the surface treatment was formed a plasma-polymerized film having a mean thickness of 200 nm. Conditions for formation of the film are as follows:

Conditions for Formation of Film

Composition of raw gas: octamethyltrisiloxane

Flow rate of raw gas: 50 sccm

Composition of carrier gas: Argon

Flow rate of carrier gas: 100 sccm

Output of high frequency power: 100 W

High frequency output density: 25 W/cm²

Pressure inside Chamber: 1 Pa (low vacuum)

Treatment time: 15 minutes

Substrate temperature: 20° C.

Under the above conditions, the plasma-polymerized film was formed on each of the substrates.

The each plasma-polymerized film thus formed is made of a polymer of octamethyltrisiloxane (raw gas). The film included an Si skeleton including a siloxane bond and having a random atomic structure and an alkyl group (a leaving group). Additionally, degree of crystallization of the plasma-polymerized film was measured by an infrared absorption method. As a result, the degree of crystallization of the plasma-polymerized film was equal to or less than 30%, although there were slight variations depending on measured portions.

In addition, regarding each of the obtained plasma-polymerized films, a refractive index with respect to light having the wavelength of 405 nm was measured.

Next, UV light was applied to the obtained plasma-polymerized films under following conditions.

Conditions for Application of UV light

Composition of Atmosphere: nitrogen atmosphere (dew point: −20° C.)

Temperature of Atmosphere: 20° C.

Pressure of Atmosphere: air pressure (100 kPa)

Wavelength of UV light: 172 nm

Application time of UV light: 600 seconds

Accumulated amount of UV light: 0.5 J/cm²

Next, plasma treatment was performed on the each obtained plasma-polymerized film under air pressure. Argon gas was used for the plasma treatment.

Next, one minute after the plasma treatment, the substrates were placed on each other such that the plasma-polymerized films contacted with each other, whereby a bonded structure was obtained.

After that, regarding the bonding film in the obtained bonded structure, again, a refractive index with respect to light having the wavelength of 405 nm was measured.

### Example 2

Each bonded structure was obtained in the same manner as in Example 1 excepting that the accumulated amount of UV light was changed to 1 J/cm².

### Example 3

Each bonded structure was obtained in the same manner as in Example 1 excepting that the accumulated amount of UV light was changed to 3 J/cm².

### Example 4

Each bonded structure was obtained in the same manner as in Example 1 excepting that the accumulated amount of UV light was changed to 6 J/cm².

### Example 5

Each bonded structure was obtained in the same manner as in Example 1 excepting that the accumulated amount of UV light was changed to 10 J/cm².

### Example 6

Each bonded structure was obtained in the same manner as in Example 4 excepting that the atmosphere for applying the UV light was changed to a pressure-reduced atmosphere.

### Example 7

Each bonded structure was obtained in the same manner as in Example 4 excepting that the atmosphere for applying the UV light was changed to an air atmosphere. A relative humidity of the air was 80%.

### Reference Example

Each bonded structure was obtained in the same manner as in Example 1 excepting that application of UV light was omitted.

### Comparative Example

Each bonded structure was obtained in the same manner as in Example 1 excepting that the base member and the object to be bonded were adhered to each other with an epoxy optical adhesive.

2. Evaluation of Bonded Structure

2-1. Evaluation of Bonding Strength (Splitting Strength)

Bonding strength was measured for each bonded structure obtained in the Examples, the Reference Example, and the Comparative Example.

Measurement of bonding strength was performed by measuring strength immediately before separation between the substrates. In addition, bonding strength was measured, immediately after bonding and after performing 100 times of temperature-cycle repetitions from −40 to 125° C. after the bonding, respectively.

As a result, bonded structures obtained in the Examples and the Reference Example had sufficient bonding strength in both of the measurement immediately after bonding and the measurement after the temperature cycle repetitions.

Meanwhile, bonded structures obtained in the Comparative Examples had sufficient bonding strength immediately after bonding, but showed reduction in the bonding strength after the temperature-cycle repetitions.

2-2. Evaluation of Size Precision

Size precision in a thickness direction (degree of parallelism) was measured for the bonded structures obtained in the Examples, the Reference Example, and the Comparative Examples.

Specifically, thicknesses of four corners of each bonded structure were measured with a micro gauge. Then, based on a difference among the thicknesses of the four corners, a relative inclination between opposite surfaces of the bonded structure was calculated.

As a result, the bonded structures obtained in the Examples and the Reference Example had a parallelism of ±1 seconds or less and also showed a small variation in parallelism among the bonded structures.

In contrast, the bonded structures obtained in the Comparative Example had a parallelism of ±1 seconds or more and also showed a large variation in parallelism among the bonded structures.

2-3. Evaluation of Refractive Index

Among bonding films obtained in the Examples and the Reference Example, refractive indexes were compared before and after the application of UV light. The refractive indexes were measured using light having the wavelength of 405 nm.

Table 1 shows evaluation results of the refractive indexes.

TABLE 1

| | Conditions for production of bonded structure | | | | | | |
|---|---|---|---|---|---|---|---|
| | | Conditions for application | | | | | |
| | | of UV light | | | Evaluation results | | |
| | | | | Accumulated | Refractive | | |
| | | Applied | Atmosphere | amount of | index after | Optical | |
| | Bonding | or not | for | UV light | bonding | transmittance | |
| | film | applied | application | (J/cm²) | (λ = 405 nm) | (λ = 405 nm) | Appearance |
| Ex. 1 | Plasma- | Applied | N2 | 0.5 | 1.563 | Good | Excellent |
| Ex. 2 | polymerized | Applied | N2 | 1 | 1.561 | Good | Excellent |
| Ex. 3 | film | Applied | N2 | 3 | 1.558 | Excellent | Excellent |
| Ex. 4 | | Applied | N2 | 6 | 1.553 | Excellent | Excellent |
| Ex. 5 | | Applied | N2 | 10 | 1.543 | Good | Excellent |
| Ex. 6 | | Applied | Pressure- | 6 | 1.553 | Excellent | Excellent |
| | | | reduced | | | | |
| Ex. 7 | | Applied | Air | 6 | 1.560 | Good | Fairly good |
| Ref-Ex | Plasma- | Not | — | — | 1.60 | Good | Excellent |
| | polymerized | applied | | | | | |
| | film | | | | | | |
| Com-Ex | Epoxy | — | — | — | 1.550 | Poor | Poor |
| | adhesive | | | | | | |

As clearly shown in Table 1, in the Examples, the refractive indexes of the bonding films subjected to UV light were lower than those of the bonding films not subjected to application of UV light. Additionally, as the accumulated amount of UV light was increased, reduction rate in the refractive indexes of the bonding films was gradually increased. Accordingly, in the Examples, it was confirmed that adjustment of the accumulated amount of UV light allowed adjustment of the refractive index of the bonding film in each bonded structure.

2-4. Evaluation of Optical transmittance

Optical transmittance (wavelength: 405 nm) in the thickness direction was measured for the bonded structures obtained in the Examples, the Reference Example, and the Comparative Example. Measurements of the Optical transmittance were performed after applying a light beam having the wavelength of 405 nm and an output of 100 mW continuously for 1000 hours in an environment of 70° C. Then, optical transmittances measured were evaluated based on evaluation criteria below.

Evaluation Criteria for Optical Transmittance

Excellent: Optical transmittance was 99.5% or higher.

Good: Optical transmittance was 99.0% or higher and lower than 99.5%.

Fairly good: Optical transmittance was 98.0% or higher and lower than 99.0%.

Poor: Optical transmittance was lower than 98.0%.

Table 1 shows the evaluation results of the optical transmittances measured.

As clear from Table 1, the bonded structures obtained in the Examples and the Reference Example had the optical transmittances of 99% or higher and thus exhibited high optical transmission properties. Meanwhile, the bonded structures obtained in the Comparative Example had sufficient optical transmission properties immediately after a start of transmission of light, but exhibited optical transmittances lower than 98% after the elapse of 1000 hours, thus showing reduction in the optical transmission properties.

2-5 Evaluation of Appearance

For the bonded structures obtained in the Examples, the Reference Example, and the Comparative Example, following the optical transmittance evaluation (2-4), appearances of portions subjected to application of the light beam were evaluated based on evaluation criteria below.

Evaluation Criteria for Appearance

Excellent: no color change or no air bubble was found on a bonded interface.

Good: slight color changes or slight air bubbles were found n a dotted pattern on the bonded interface.

Fairly good: many color changes or air bubbles were found in a dotted pattern on the bonded interface.

Poor: many color changes or air bubbles were found in a layered pattern on the bonded interface.

Table 1 shows the evaluation of the appearances obtained.

As clear from Table 1, no color changes or no air bubbles were observed at all on the bonded interface in each of the bonded structures obtained in the Examples and the Reference Example. However, in the bonded structures obtained in the Comparative Example, color changes were found in an optical path, after the above optical transmittance evaluation (2-4).

What is claimed is:

1. A bonding method, comprising:
forming a bonding film on a surface of a base member by plasma polymerization, the bonding film including an Si skeleton of a random atomic structure including a siloxane (Si—O) bond and leaving groups binding to the Si skeleton;
applying UV light to the bonding film to eliminate the leaving groups at a surface of the bonding film from the Si skeleton so as to provide adhesion properties to the bonding film, an accumulated amount of the LTV light being adjusted to control a refractive index of the bonding film; and
bonding the base member and an object together via the bonding film to obtain a bonded structure.

2. The bonding method according to claim 1, wherein, in all atoms except for H atoms included in the bonding film, a sum of Si atoms and O atoms ranges from 10 to 90 atom percent.

3. The bonding method according to claim 1, wherein a ratio of the Si atoms and the O atoms in the bonding film ranges from 3:7 to 7:3.

4. The bonding method according to claim 1, wherein a degree of crystallization of the Si skeleton is equal to or less than 45%.

5. The bonding method according to claim 1, wherein the bonding film includes an Si—H bond.

6. The bonding method according to claim 5, wherein, when a peak intensity of the siloxane bond is set to 1 in an infrared absorption spectrum of the bonding film including the Si—H bond, a peak intensity of the Si—H bond ranges from 0.001 to 0.2.

7. The bonding method according to claim 1, wherein the leaving groups include at least one of an H atom, a B atom, a C atom, an N atom, an O atom, a P atom, an S atom, a halogen atom, and an atom group in which each of the atoms is arranged so as to bind to the Si skeleton.

8. The bonding method according to claim 7, wherein the leaving groups are alkyl groups.

9. The bonding method according to claim 8, wherein when the peak intensity of the siloxane bond is set to 1 in the infrared absorption spectrum of the bonding film including methyl groups as the leaving groups, a peak intensity of the methyl groups ranges from 0.05 to 0.45.

10. The bonding method according to claim 1, wherein the bonding film includes an active bond after the leaving groups present at least near a surface of the bonding film are eliminated from the Si skeleton.

11. The bonding method according to claim 10, wherein the active bond is a dangling bond or a hydroxyl group.

12. The bonding method according to claim 1, wherein the bonding film is mainly made of polyorganosiloxane.

13. The bonding method according to claim 12, wherein the polyorganosiloxane predominantly contains a polymer of octamethyltrisiloxane.

14. The bonding method according to claim 1, wherein, in the plasma polymerization, a high frequency output density for generating plasma ranges from 0.01 to 100 W/cm².

15. The bonding method according to claim 1, wherein a mean thickness of the bonding film ranges from 1 to 1,000 nm.

16. The bonding method according to claim 1, wherein the bonding film is a solid having no fluidity.

17. The bonding method according to claim 1, wherein the refractive index of the bonding film is adjusted to a predetermined value ranging from 1.35 to 1.6.

18. The bonding method according to claim 1, wherein, at the UV-light application step, the UV light has a wavelength ranging from 126 to 300 nm.

19. The bonding method according to claim 1, wherein, at the UV-light application step, the accumulated amount of the UV light ranges from 10 mJ/cm² to 1 kJ/cm².

20. The bonding method according to claim 1, wherein, at the UV-light application step, an atmosphere for applying the UV light to the bonding film is a dry atmosphere.

21. The bonding method according to claim 1, wherein, at the UV-light application step, an atmosphere for applying the UV light to the bonding film is an inert gas atmosphere.

22. The bonding method according to claim 1, wherein at least one of the base member and the object to be bonded is made of a light-transmitting material, and at the UV-light application step, the refractive index of the bonding film is adjusted in accordance with a refractive index of the light-transmitting material.

23. The bonding method according to claim 22, wherein the light-transmitting material is quartz glass or quartz crystal.

24. The bonding method according to claim 1 further including exposing the bonding film to plasma between the UV-light application step and the bonding step.

25. The bonding method according to claim 24, wherein the plasma is atmospheric pressure plasma.

26. The he bonding method according to claim 1, wherein, the bonding-film formation step further comprises forming a second bonding film on a surface of the object to be boded; then, at the UV-light application step, the UV light is applied to both of the bonding films; and, at the bonding step, the base member and the object to be bonded are bonded together such that the bonding films are closely adhered to each other so as to obtain the bonded structure.

27. A bonded structure including two base members bonded by the bonding method of claim 1.

28. An optical element including the bonded structure of claim 27.
